(19) United States
(12) Patent Application Publication
(10) Pub. No.: US 2004/0042061 A1
(43) Pub. Date: Mar. 4, 2004

(54) Controlling ASE in optical amplification stages implementing time modulated pump signals

(76) Inventors: Mohammed N. Islam, Allen, TX (US); Michael J. Freeman, Northville, MI (US); Amos Kuditcher, Allen, TX (US)

Correspondence Address: BAKER BOTTS L.L.P., 2001 ROSS AVENUE, SUITE 600, DALLAS, TX, 75201-2980, US

(21) Appl. No.: 10/232,350

(22) Filed: Aug. 30, 2002

(51) Int. Cl. H01S 3/00

(52) U.S. Cl. 359/334

(57) ABSTRACT

An optical amplifier includes at least one Raman amplification stage. The Raman amplification stage includes one or more pump sources operable to generate a plurality of pump signals capable of being delivered to a gain medium carrying an optical signal. In one particular embodiment, at least one of the plurality of pump signals comprises a time modulated pump signal and wherein an amplified spontaneous emission penalty associated with the at least one time modulated pump signal comprises no more than fifteen (15) decibels.

### CROSS-REFERENCE TO RELATED CASES

This application claims priority to U.S. application Ser. No. 10/100,590, entitled “Enhancing Gain and/or Noise Figure of Raman Amplifier Stages Using Time Modulated Pump Signals,” filed on Mar. 15, 2002, which claims priority to U.S. application Ser. No. 10/032,111, entitled “Time Modulated Pumping of Raman Amplifier Stages,” filed on Dec. 20, 2001.

### TECHNICAL FIELD OF THE INVENTION

The present invention relates generally to communication systems, and more particularly to a system and method for time modulating pump signals in optical amplifiers comprising at least one Raman amplification stage.

Overview

Raman amplifiers typically operate by pumping a gain medium carrying optical signals with one or more pump signals each having one or more wavelengths. The Raman effect leads to a transfer of energy from a shorter wavelength pump beam to a longer wavelength signal beam. While the Raman effect leads to energy transfer from the pump signals to the signals being amplified, it can also lead to an energy transfer from one pump signal to another. Many amplifier designers have considered this interaction to be harmful, and have sought to avoid interaction between pump signals. In these systems, the relative wavelength spacing of the pump signals provides the primary mechanism for avoiding interaction between pump signals.

### SUMMARY OF EXAMPLE EMBODIMENTS

The present invention recognizes a need for a system and method for improving the operation of optical amplifiers comprising at least one Raman amplification stage.

In one embodiment, an optical amplifier comprises at least one Raman amplification stage. The Raman amplification stage comprises one or more pump sources operable to generate a plurality of pump signals capable of being delivered to a gain medium carrying an optical signal. In one particular embodiment, at least one of the plurality of pump signals comprises a time modulated pump signal. In addition, an amplified spontaneous emission penalty associated with the at least one time modulated pump signal comprises no more than fifteen (15) decibels.

In another embodiment, an optical amplifier comprises at least one Raman amplification stage. The Raman amplification stage comprises one or more pump sources operable to generate a plurality of pump signals capable of being delivered to a gain medium carrying an optical signal. In one particular embodiment, at least one of the plurality of pump signals comprises a time modulated pump signal. In addition, at least one waveform characteristic of the time modulated pump signal is selected to maintain a ratio of a time-averaged amplified spontaneous emission (ASE) power level to a minimum ASE power level of less than thirty (30). The time-averaged ASE power level and the minimum ASE power level co-propagate with the at least one time modulated pump signal.

In yet another embodiment, an optical amplifier comprises at least one Raman amplification stage. The Raman amplification stage comprises one or more pump sources operable to generate a plurality of pump signals capable of being delivered to a gain medium carrying an optical signal. In one particular embodiment, at least one of the plurality of pump signals comprises a time modulated pump signal. In addition, a modulation rate of the time modulated pump signal is no more than 10 megahertz and another waveform characteristic of the time modulated pump signal is selected to reduce a noise figure of the amplifier stage.

In still another embodiment, an optical amplifier comprises at least one Raman amplification stage. The Raman amplification stage comprises one or more pump sources operable to generate a plurality of pump signals capable of being delivered to a gain medium carrying an optical signal. In one particular embodiment, at least one of the plurality of pump signals comprises a time modulated pump signal. In addition, a modulation repetition rate of the time modulated pump signal is selected to provide a noise figure degradation of one (1) decibel or less for at least some wavelengths of the optical signal.

In a method embodiment, a method of amplifying optical signals in a Raman amplification stage comprises generating a plurality of pump signals, where at least one of the plurality of pump signals comprises a time modulated pump signal. The method further comprises introducing the plurality of pump signals to a gain medium carrying an optical signal. In one particular embodiment, an amplified spontaneous emission penalty associated with the at least one time modulated pump signal comprises no more than fifteen (15) decibels.

In another method embodiment, a method of amplifying optical signals in a Raman amplification stage comprises generating a plurality of pump signals capable of being delivered to a gain medium carrying an optical signal. In one particular embodiment, at least one of the plurality of pump signals comprises a time modulated pump signal. The method further comprises selecting at least one waveform characteristic of the time modulated pump signal to maintain a ratio of a time-averaged amplified spontaneous emission (ASE) power level to a minimum ASE power level of less than thirty (30). The time-averaged ASE power level and the minimum ASE power level co-propagate with the at least one time modulated pump signal.

In yet another method embodiment, a method of amplifying optical signals in a Raman amplification stage comprises generating a plurality of pump signals capable of being delivered to a gain medium carrying an optical signal. In one particular embodiment, at least one of the plurality of pump signals comprises a time modulated pump signal and a modulation rate of the time modulated pump signal comprises no more than 10 megahertz. The method further comprises selecting another waveform characteristic of the time modulated pump signal to reduce a noise figure of the amplifier stage.

Depending on the specific features implemented, particular embodiments of the present invention may exhibit some, none, or all of the following technical advantages. Various embodiments optimize the gain and noise figure of an amplification stage implementing at least one time modulated pump signal. Some embodiments may be capable of manipulating waveform characteristics of a time modulated pump signal to control the relative power of an amplified spontaneous emission (ASE) signal that co-propagates with the time modulated pump signal. Other embodiments may be capable of removing at least a portion of the ASE signal that co-propagates with a time modulated pump signal.

Other technical advantages will be readily apparent to one skilled in the art from the following figures, descriptions, and claims. Moreover, while specific advantages have been enumerated above, various embodiments may include all, some or none of the enumerated advantages.

### BRIEF DESCRIPTION OF THE DRAWINGS

For a more complete understanding of the present invention, and for further features and advantages thereof, reference is now made to the following description taken in conjunction with the accompanying drawings, in which:

FIG. 1 is a block diagram showing at least a portion of an exemplary optical communication system 10 operable to facilitate communication of one or more multiple wavelength signals;

FIG. 2 is a block diagram showing an exemplary optical amplifier implementing at least some aspects of the present invention;

FIGS. 3-6 are block diagrams showing exemplary pump arrangements for use in a Raman amplification stage;

FIGS. 7a-7c are timing diagrams showing example interaction between time modulated pump wavelength signals;

FIGS. 8a-8h illustrate simulated interactions between two time modulated pump signals utilizing initially equal maximum pump powers;

FIGS. 9a-9h illustrate simulated interactions between two time modulated pump signals utilizing initially unequal maximum pump powers;

FIG. 10 is a portion of a timing diagram showing portions of a continuous wave (CW) pump signal and a time modulated pump signal;

FIGS. 11a-11b are graphs illustrating experimental results showing improvements in gain and noise figures for an amplifier stage using time modulated pump signals compared to the same amplifier using CW pump signals;

FIG. 12 is a graph comparing operation of an amplifier stage driven by CW pumps to the same amplifier stage driven by time modulated pump signals;

FIGS. 13a-13b are graphs further illustrating how the initial phase difference between time modulated pump signals can affect the gain and noise figure of an amplifier;

FIGS. 14a-14b are graphs comparing experimental results of gain and noise figures, respectively, of an amplifier using CW pump signals to the same amplifier using time modulated pump signals;

FIG. 15 is a block diagram illustrating one example of an amplification stage capable of manipulating waveform characteristics to control and/or minimize the effect of ASE signals on a noise figure associated with the amplification stage;

FIG. 16 is a graph illustrating the impact of Rayleigh scattered ASE on a noise figure of an amplification stage implementing a time modulated pump signal with a relatively low modulation repetition rate;

FIGS. 17A and 17B are graphs illustrating the effect of manipulating a modulation repetition rate of a time modulated pump signal on a noise figure of various optical signal wavelengths amplified within an amplification stage;

FIG. 18 is a graph illustrating the effect of manipulating a modulation repetition rate of a time modulated pump signal on the relative power of ASE signals that co-propagate with the time modulated pump signal;

FIG. 19 is a graph illustrating the effect of manipulating a duty cycle of a time modulated pump signal on the magnitude of ASE that co-propagates with the time modulated pump signal;

FIG. 20 is a graph illustrating the effect of manipulating a modulation depth (e.g., extinction ratio) of a time modulated pump signal on the magnitude of ASE that co-propagates with the time modulated pump signal;

FIGS. 21A and 21B are graphs illustrating experimental results showing the effect of manipulating the modulation repetition rate on the relative power of the ASE signal generated by a time modulated pump signal;

FIG. 22 is a block diagram illustrating a multiple stage discrete Raman amplifier capable of minimizing the effect of ASE on a noise figure associated with amplifier; and

FIG. 23 is a flow chart illustrating one example of a method of amplifying optical signals using at least one time modulated pump signal.

### DETAILED DESCRIPTION OF EXAMPLE EMBODIMENTS

FIG. 1 is a block diagram showing at least a portion of an exemplary optical communication system 10 operable to facilitate communication of one or more multiple wavelength signals 16. Each multiple wavelength signal 16 comprises a plurality of optical wavelength signals (or channels) 15a-15n, each comprising a center wavelength of light. In some embodiments, each optical signal 15a-15n can comprise a center wavelength that is substantially different from the center wavelengths of other signals 15. As used throughout this document, the term “center wavelength” refers to a time-averaged mean of the spectral distribution of an optical signal. The spectrum surrounding the center wavelength need not be symmetric about the center wavelength. Moreover, there is no requirement that the center wavelength represent a carrier wavelength.

In this example, system 10 includes a transmitter assembly 12 operable to generate the plurality of optical signals (or channels) 15a-15n. Transmitters 12 can comprise any devices capable of generating one or more optical signals. Transmitters 12 can comprise externally modulated light sources, or can comprise directly modulated light sources.

In one embodiment, transmitter assembly 12 comprises a plurality of independent optical sources each having an associated modulator, with each source being operable to generate one or more wavelength signals 15. Alternatively, transmitter assembly 12 could comprise one or more optical sources shared by a plurality of modulators. For example, transmitter assembly 12 could comprise a continuum source transmitter including a mode-locked source operable to generate a series of optical pulses and a continuum generator operable to receive a train of pulses from the mode-locked source and to spectrally broaden the pulses to form an approximate spectral continuum of optical signals. In that embodiment, a signal splitter receives the continuum and separates the continuum into individual signals each having a center wavelength. In some embodiments, transmitter assembly 12 can also include a pulse rate multiplexer, such as a time division multiplexer, operable to multiplex pulses received from the mode locked source or the modulator to increase the bit rate of the system.

Transmitter assembly 12 may, in some cases, comprise a portion of an optical regenerator. That is, transmitter assembly 12 may generate optical signals 15 based on electrical representations of electrical or optical signals received from other optical communication links. In other cases, transmitter assembly 12 may generate optical signals 15 based on information received from sources residing locally to transmitters 12. Transmitter assembly 12 could also comprise a portion of a transponder assembly (not explicitly shown), containing a plurality of transmitters and a plurality of receivers.

In the illustrated embodiment, system 10 also includes a combiner 14 operable to receive wavelength signals 15a-15n and to combine those signals into a multiple wavelength signal 16. As one particular example, combiner 14 could comprise a wavelength division multiplexer (WDM). The terms wavelength division multiplexer and wavelength division demultiplexer as used herein may include equipment operable to process wavelength division multiplexed signals and/or equipment operable to process dense wavelength division multiplexed signals.

System 10 communicates multiple wavelength signal 16 over an optical communication medium 20. Communication medium 20 can comprise a plurality of spans 20a-20n of fiber. Fiber spans 20a-20n could comprise standard single mode fiber (SMF), dispersion-shifted fiber (DSF), non-zero dispersion-shifted fiber (NZDSF), dispersion compensating fiber (DCF), or another fiber type or combination of fiber types.

Two or more spans of communication medium 20 can collectively form an optical link. In the illustrated example, communication medium 20 includes a single optical link 25 comprising numerous spans 20a-20n. System 10 could include any number of additional links coupled to link 25. For example, optical link 25 could comprise one optical link of a multiple link system, where each link is coupled to other links through, for example, optical regenerators.

Optical communication link 25 could comprise, for example, a unidirectional link or a bi-directional link. Link 25 could comprise a point-to-point communication link, or could comprise a portion of a larger communication network, such as a ring network, a mesh network, a star network, or any other network configuration.

System 10 may further include one or more access elements 27. For example, access element 27 could comprise an add/drop multiplexer, a cross-connect, or another device operable to terminate, cross-connect, switch, route, process, and/or provide access to and from optical link 25 and another optical link or communication device. System 10 may also include one or more lossy elements (not explicitly shown) and/or gain elements capable of at least partially compensating for the lossy element coupled between spans 20 of link 25. For example, the lossy element could comprise a signal separator, a signal combiner, an isolator, a dispersion compensating element, a circulator, or a gain equalizer.

In this embodiment, a separator 26 separates individual optical signal 15a-15n from multiple wavelength signal 16 received at the end of link 25. Separator 26 may comprise, for example, a wavelength division demultiplexer (WDM). Separator 26 communicates individual signal wavelengths or ranges of wavelengths to a bank of receivers 28 and/or other optical communication paths. One or more of receivers 28 may comprise a portion of an optical transceiver operable to receive and convert signals between optical and electrical formats.

System 10 includes a plurality of optical amplifiers coupled to communication medium 20. In this example, system 10 includes a booster amplifier 18 operable to receive and amplify wavelengths of signal 16 in preparation for transmission over a communication medium 20. Where communication system 10 includes a plurality of fiber spans 20a-20n, system 10 can also include one or more in-line amplifiers 22a-22m. In-line amplifiers 22 couple to one or more spans 20a-20n and operate to amplify signal 16 as it traverses communication medium 20. The illustrated example also implements a preamplifier 24 operable to amplify signal 16 received from a final fiber span 20n prior to communicating signal 16 to separator 26. Although optical link 25 is shown to include one or more booster amplifiers 18 and preamplifiers 24, one or more of the amplifier types could be eliminated in other embodiments.

Amplifiers 18, 22, and 24 could each comprise, for example, one or more stages of discrete Raman amplification stages, distributed Raman amplification stages, rare earth doped amplification stages, such as erbium doped or thulium doped stages, semiconductor amplification stages or a combination of these or other amplification stage types. In some embodiments, amplifiers 18, 22, and 24 could each comprise bi-directional Raman amplifiers. Throughout this document, the term “amplifier” denotes a device or combination of devices operable to at least partially compensate for at least some of the losses incurred by signals while traversing all or a portion of optical link 25. Likewise, the terms “amplify” and “amplification” refer to offsetting at least a portion of losses that would otherwise be incurred.

An amplifier may, or may not impart a net gain to a signal being amplified. Moreover, the terms “gain” and “amplify” as used throughout this document, do not (unless explicitly specified) require a net gain. In other words, it is not necessary that a signal experiencing “gain” or “amplification” in an amplifier stage experience enough gain to overcome all losses in the amplifier stage or in the fiber connected to the amplifier stage. As a specific example, distributed Raman amplifier stages typically do not experience enough gain to offset all of the losses in the transmission fiber that serves as a gain medium. Nevertheless, these devices are considered “amplifiers” because they offset at least a portion of the losses experienced in the transmission fiber.

Depending on the amplifier types chosen, one or more of amplifiers 18, 22, and/or 24 could comprise a wide band amplifier operable to amplify all signal wavelengths 15a-15n received. Alternatively, one or more of those amplifiers could comprise a parallel combination of narrower band amplifier assemblies, wherein each amplifier in the parallel combination is operable to amplify a portion of the wavelengths of multiple wavelength signal 16. In that case, system 10 could incorporate signal separators and/or signal combiners surrounding the parallel combinations of amplifier assemblies to facilitate amplification of a plurality of groups of wavelengths for separating and/or combining or recombining the wavelengths for communication through system 10.

At least one amplifier in system 10 comprises a Raman amplification stage comprising a gain medium driven by a plurality of pump signals, wherein at least one of the pump signals comprises a time modulated pump signal. The time modulated pump signal varies in power as it traverses the gain medium of the amplification stage. The minimum power may comprise zero power, or may comprise a non-zero power level. Moreover, the time modulated waveform pattern can take any form. Squarewaves, sinusoids, and triangle waveforms are just a few examples.

The modulation of the pump signal can occur on a periodic, or other basis. Variations in periodicity such as system jitter are not intended to denote a non-periodic system. Typically, the time modulated pump signal will have a repetitive waveform pattern and a repetition rate, although the rate may vary intentionally, or unintentionally to some extent during the operation of the amplifier. For complicated pump modulation waveforms, the modulation repetition rate can be defined as one-half (½) the number of times the waveform crosses through its average power.

Various embodiments may implement waveforms having repetition rates as high as 100 kilohertz or higher. Other embodiments may implement much higher modulation repetition rates, such as, 500 kilohertz, 1 megahertz, 10 megahertz, 30 megahertz, or higher. Using high modulation repetition rates provides an advantage of reducing variations of the peak junction temperature of the pumps. For example, using high modulation repetition rates can result in the time modulated pump exhibiting thermal characteristics that resemble direct current operation. It can be, therefore, advantageous to set the modulation repetition rate faster than the thermal constant of the pump source.

By modulating the peak power of the pump, the pump sources can be driven to peak powers that exceed the rated CW peak power of the source without exceeding the rated thermal limitations of the pump. In some cases, the time modulated peak power of the pump can exceed the CW rated peak power by as much as twenty (20) percent or more, fifty (50) percent or more, one hundred (100) percent or more, or even more than two hundred (200) percent.

Using high modulation repetition rates also provides an advantage of reducing time variances in the gain applied to signals in the gain medium. The modulation repetition rate can be set significantly higher than the transit time the pump signal experiences through the gain medium. In one embodiment, the modulation repetition rate can be selected to ensure that all signals input to the gain medium experience at least one complete period of the time modulated pump signal. In other embodiments, the modulation repetition rate can be selected to ensure that all signals input to the gain medium experience at least one complete period of the time modulated pump signal for each unit of distance of gain medium, for example, at least one cycle per kilometer of gain fiber. In these ways, signals traversing the gain medium at one time will experience substantially the same gain as signals traversing the gain medium during another time period.

In some cases, relatively high modulation repetition rates can further provide an advantage of controlling the effect of Rayleigh scattered ASE signals on a noise figure of the amplifier. This is because chromatic dispersion causes the co-propagating ASE signal and the pump signal to travel at slightly different speeds due to differences in wavelength. The modulation repetition rates can, therefore, be set sufficiently high to provide adequate walk off, relative to the modulation cycle times, between a time modulated pump signal and an ASE signal co-propagating with the time modulated pump signal. In some cases, using high modulation repetition rates can thus result in a reduction of the ASE signal power co-propagating with the time modulated pump signal and reduce the effect of the Rayleigh scattered ASE signal on the noise figure.

In at least some embodiments, it can be advantageous to select a lower repetition rate. In such cases, the selection of the peak power and the repetition rate can also be influenced by the selection of the duty cycle for the signal. Each time modulated pump signal typically includes a higher power portion and a lower power portion. For simplicity of discussion, the high power portion can be considered that portion having a power greater than the average power of the signal. The lower power portion can be considered that part of the time modulated pump signal having a power less than the average power of the signal. The time modulated pump signal varies between the higher power portion and the lower power portion.

In various embodiments, the time modulated pump signal may have a duty cycle in which the higher power portion of the signal comprises, say, at least twenty percent (20%) of the modulation period. Other embodiments can implement modulation techniques where higher power portions comprise as much as thirty percent (30%) or even as much as ninety percent (90%) or more of the modulation period. Still other embodiments implement modulation techniques where higher power portions comprise no more than thirty percent (30%) of the modulation period.

In addition, the selection of the peak power, modulation repetition rate, and duty cycle can also be influenced by the selection of an extinction ratio or modulation depth. The extinction ratio (ER) refers to the ratio of the highest power of a modulation period to the lowest power of the modulation period of the time modulated pump signal (e.g., P_{MAX}÷P_{MIN}). As used in this document, the term “modulation depth” refers to a measurement that is equivalent to the extinction ratio, but expressed in dB (e.g., 10×log₁₀ (ER)).

In various embodiments, the time modulated pump signal may have an extinction ratio of 20:1 (e.g., a modulation depth of approximately thirteen (13) decibels) or more. In other embodiments, the time modulated pump signal can have an extinction ratio of 10:1 (e.g., a modulation depth of approximately ten (10) decibels) or more. Still other embodiments can implement an extinction ratio of 10:1 or less, or 5:1 or less.

Not all pump signals need be time modulated pump signals. Others of the plurality of pump signals may comprise non-modulated or continuous wave (CW) pump signals having approximately constant launch powers and/or may comprise additional time modulated pump signals. Throughout this document the term “nonmodulated” and “continuous wave” pump signal refer to a pump signal whose power is not intentionally varied during operation, at least not while system conditions remain approximately constant. Pumps whose power is varied due to, for example, changes in signal power or spectral distribution, changes in the temperature of one or more components, changes due to the aging of components, and/or changes in the power provided by other pumps in the system are not intended to be excluded from the definition of a “non-modulated” signal.

System 10 provides great flexibility in controlling one or more characteristics of the modulation waveform to control the temporal overlap of non-zero power signal portions of different pump signals while traversing the gain medium of the amplification stage. For example, the modulation waveform can be controlled by selecting the waveform pattern, the pattern repetition rate, the timing of the leading edges of pulses (or other waveforms) in different time modulated pump signals, the maximum and minimum power levels of the pump signals, the duration of maximum power application in the time modulated pump signals, and/or the duty cycle of the signal. Any one or all of these characteristics could be selected to control or prevent power transfer among pump signals. Moreover, the length of the gain medium, and/or the dispersion characteristics of the gain medium can be chosen to affect the temporal overlap between various pump signals while traversing the gain medium.

Using various combination of these (and possibly other factors as well), system 10 can regulate when, where, and how long, if at all, and how much any two or more pump signals overlap while traversing the gain medium. In this manner, system 10 provides various degrees of freedom in controlling an amount of interaction between different pump signals. As a result, system 10 facilitates control of energy transfer between pump signals. This can provide significant advantages in facilitating and controlling desirable pump interaction when and where it is appropriate, as well as in reducing unwarranted pump interaction.

In one embodiment, by controlling one or more time modulated pump signals, Raman interaction between pump signals can be enhanced. This can lead to increased gain and a corresponding reduction in noise figure for the amplifier stage. In some embodiments, one or more time modulated pump sources can be driven at high peak power levels, while using lower average pump powers. This can result in increased gain and a lower noise figure of the amplifier stage for a given average pump power. In some cases, a time modulated pump source can be operated at peak power levels exceeding a peak power level for which the source is rated during continuous wave (CW) operation. Using time modulated drive current signals, the pump sources can be driven beyond their rated CW capacities without causing thermal damage to the pump source.

Additionally, controlling one or more time modulated pump signals can reduce the noise figure of the amplifier stage, by delaying the location along the gain fiber where gain is introduced to the optical signal traversing the gain fiber. As a particular example, where time modulated pump signals propagate counter to the signals being amplified, it can be desirable to enable the pump signal to penetrate as far as possible toward the signal input end of the gain medium. Controlling when and where, if at all, pump signals interact with one another along a gain medium can facilitate propagation of one or more pump signals further along the gain medium. This can allow counter-propagating pump signals to amplify optical signals closer to the input side of the gain medium, before the optical signals experience significant losses. Amplifying the signals before significant losses are incurred generally improves the noise figure for the amplifier stage.

Another advantage to controlling interaction between pump wavelengths is the ability to implement relatively uniform average launched pump powers, while tailoring the gain profile of the amplification stage. Many conventional amplification techniques rely on applying different pump powers at different wavelengths to impart a desired gain spectrum. Using conventional techniques, the powers launched at each wavelength are constrained by pump-pump Raman interactions and are often not very uniform. In some cases, the wavelength with the highest power can have much more power than the wavelength with the lowest power (e.g., more than 5 times the power).

In one embodiment, by intentionally allowing the pump signals to interact with one another, and controlling that interaction, system 10 allows the flexibility to use pumps having more uniform average launched pump powers, if desired. This could decrease the cost of the amplifier by allowing for more uniform pumps to generate various wavelength pump signals and allowing for more simple control systems to control gain uniformity.

Still another advantage of this technique is the ability to control interaction between pump signals to affect the shape of a gain profile of the amplifier stage. For example, it may be desired that the gain profile remain approximately flat across the bandwidth of signals being amplified. Or, it may be desired to have a sloped gain profile, for example, in combination with an approximately complementary sloped gain profile in another amplification stage to result in low noise or high pump efficiency operation. The shape of the gain profile for the amplifier stage can be affected and controlled, at least to some extent, by controlling when, where, and how much various wavelength pump signals interact with one another.

Although these examples have been described with reference to a time modulated pump signal accepting energy from another pump signal, time modulated pump signals could also give energy to other pump signals having longer wavelengths. For example, a comparatively shorter wavelength time modulated pump signal could provide energy to a relatively longer wavelength non-modulated pump signal or to a relatively longer wavelength time modulated pump signal.

In some embodiments, system 10 can also control the effect of Rayleigh scattered amplified spontaneous emission (ASE) signals on the noise figure of an amplification stage by manipulating one or more modulation waveform characteristics. For example, manipulating a modulation repetition rate, a duty cycle, an extinction ratio, and/or a peak power of the modulation waveform can control and/or minimize the impact of Rayleigh scattered ASE signals on the noise figure of the amplification stage. Using any one or a combination of these factors, and possibly other factors as well, system 10 can regulate the relative power of the ASE signals co-propagating with any time modulated pump signal and generated while traversing a gain medium or a transmission fiber. In this manner, system 10 can provide various degrees of freedom in controlling and/or minimizing the impact of the Rayleigh scattered ASE signals on the noise figure, while achieving a desired gain for the amplification stage.

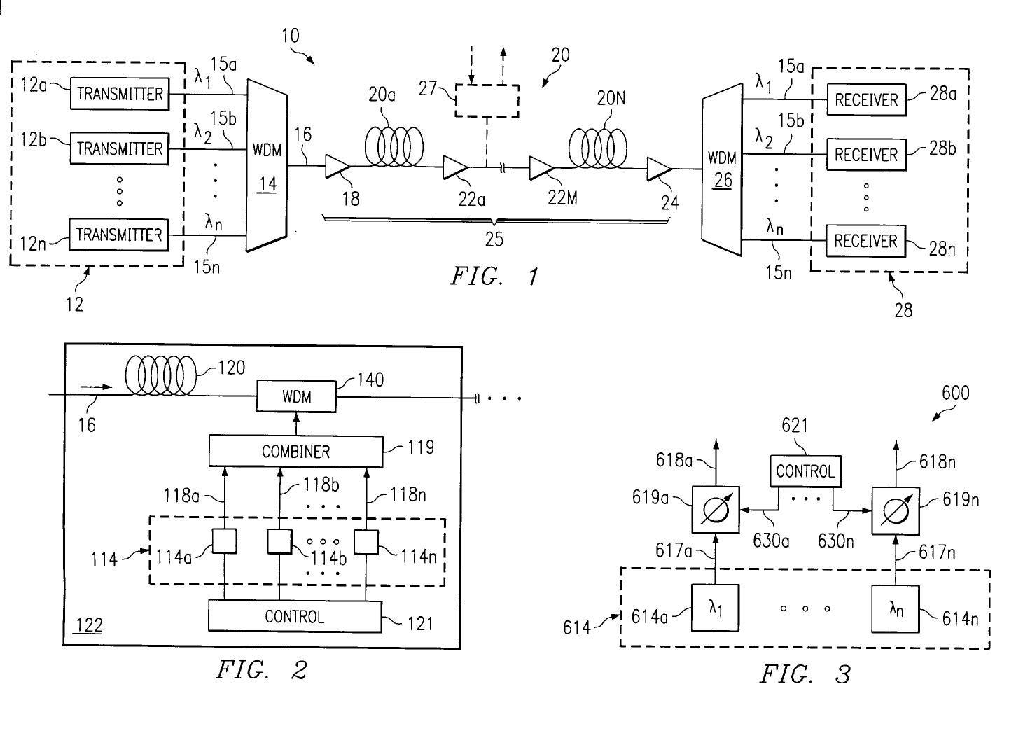

FIG. 2 is a block diagram showing one example of a Raman amplification stage 122. Raman amplifier stage 122 could comprise a single amplifier stage in a one-stage Raman amplifier, or could comprise one of a plurality of amplifier stages in a multiple stage amplifier. Moreover, amplifier stage 122 could reside within an all-Raman amplifier or could be part of a hybrid amplifier comprising one or more stages of Raman amplification and one or more stages of another amplification type, such as rare earth doped amplification.

In this example, Raman amplification stage 122 includes a gain medium 120 operable to receive multiple wavelength signal 16 carrying a plurality of optical signals each having a center wavelength. Gain medium 120 can comprise, for example, a distributed medium such as a transmission fiber or a spooled gain fiber, or could comprise a discrete gain medium such as a spooled gain fiber.

Amplifier stage 122 further comprises a pump assembly 114 operable to generate a plurality of pump signals 118a-118n. In one embodiment, pump assembly 114 could comprise a plurality of individual optical sources each operable to generate one pump signal 118. Alternatively, pump assembly 114 could comprise one or more light sources operable to generate a plurality of pump signals 118. As a particular example, pump assembly 114 could comprise one or more continuum sources.

Amplifier stage 122 comprises one or more combiners 140 operable to introduce one or more pump signals 118 to gain medium 120. Combiners 140 could comprise, for examples wavelength division multiplexers or other optical coupling devices. In this particular embodiment, combiner 140 facilitates propagating at least some of pump signals 118 counter to the direction of propagation of multiple wavelength signal 16 through gain medium 120. In particular, with respect to time modulated pump signals, the use of counter-propagating pump signals provides an advantage of reducing time dependant variations in gain provided to multiple wavelength signal 16 as it traverses gain medium 120. In other embodiments, co-propagating pump signals could be used, or a combination of co-propagating and counter-propagating pump signals could be used. In one embodiment, time modulated pump signals could be counter-propagating, while non-modulated pump signals could be co-propagating.

In the illustrated example, amplifier stage 122 includes a pump signal combiner 119 operable to combine some or all of pump signals 118a-118n into a multiple wavelength pump signal for combination with gain medium 120. Alternatively, one or more pump signals 118a-118n could be introduced to gain medium 120 using separate combiners 140. In that case, pump signals associated with different combiners 140 can be introduced at different locations in gain medium 120.

At least one pump signal 118a comprises a time modulated pump signal. The designation in this example of pump signal 118a as a time modulated pump signal is not intended to imply that any particular wavelength pump signal 118a-118n must be time modulated. Any one or more pump signals 118a-118n could be time modulated.

In a particular example, time modulated pump signal 118a could comprise a signal that periodically varies between a higher power portion and a lower power portion. The term “higher power portion” refers to a portion of an optical signal having a power greater than the average power of the signal. In some embodiments, the lower power portion could comprise a zero power portion. In other embodiments, the lower power portion may comprise a non-zero power, which is lower in power than the higher power portion. The time modulated pump signal could vary between the higher power portion and lower power portion in any manner. For example, the variance may result in a square waveform, a sinusoidal waveform, a triangle waveform, or other gradual or immediate transition between higher and lower power portions.

The characteristics of the modulation waveform of time-modulated pump signal 118a can be selected to control the amount of time that non-zero power portions of pump signal 118a, or in some cases the higher power portions of signal 118a, interact with non-zero power portions of other pump signals 118. These characteristics can include, for example, the maximum and minimum powers of that time modulated pump signal compared to those powers in other pump signals 118, the repetition pattern of the waveform, the repetition rate of the waveform, the starting time of the waveform, the duty cycle, the duration of maximum power, the extinction ratio, the length of gain medium 120, and/or dispersion characteristics of gain medium 120, to name a few.

Amplifier assembly 122 further includes or has access to a control module 121. Control module 121 could comprise any software, hardware, firmware, or combination thereof operable to affect a change in one or more characteristics of time modulated pump signal 118a to affect the amount of interaction between time modulated pump signal 118a and other pump signals 118. In this example, control module 121 is shown as residing locally to amplifier stage 122. Alternatively, control module 121 could reside remotely from and accessible to amplifier stage 122. Moreover, although control module 121 is shown as serving only amplifier stage 122, control module 121 could alternatively serve any number of amplifier stages in one or more optical links.

The example shown in FIG. 2 depicts a plurality of time-modulated pump signals (e.g., 118a and 118n) as well as one or more non-modulated pump signals (e.g., 118b). Where a plurality of time modulated pump signals 118 are implemented, it can be desirable to synchronize the plurality of time modulated pump signals as they enter gain medium 120. For example, depending on the distances between pump sources 114 and gain medium 120, or the distances between controller 121 and various pump sources 114, different pump signals can experience different delays in reaching gain medium 120. To ensure that the selected modulation achieves its full desired effect, it may be desirable to measure these time differences and account for them before pump signals 114 enter gain medium 120. This could be implemented, for example, automatically, through controller 121, or through other software, hardware, firmware, or combination thereof.

In operation, gain medium 120 receives multiple wavelength signal 16 and a plurality of pump signals 118a-118n. In this example, multiple wavelength signal 16 progresses in one direction along gain medium 120, while at least some pump signals 118 travel in the opposite direction through gain medium 120. Raman gain results when pump signals 118 provide energy to optical signals of multiple wavelength signal 16 and excite phonons in gain medium 120.

At least one of pump signals 118 comprises a time-modulated pump signal having a modulation waveform selected to control interaction of that pump signal 118a with other pump signals 118 traversing gain medium 120. One or more time-modulated pump signals 118 can be configured to selectively interact with other pump signals 118 at desired locations along gain medium 120 to provide desired gain levels at those locations.

The interaction between a time modulated pump signal and another pump signal (whether time modulated or non-modulated) depends at least in part on the dispersion characteristics of gain medium 120. Different wavelengths of light will travel at different speeds through an optical medium depending on the dispersion characteristics of the medium. By selecting or knowing the dispersion characteristics of gain medium 120 and the length of gain medium 120, and by knowing the group velocity near the center wavelength of each pump signal, a modulation waveform can be selected.

The modulation waveforms will determine where, if at all, along gain fiber 120 time modulated pump signals 118 will interact with each other and/or with other non-modulated pump signals 118. By tailoring the level of interaction of pump signals from no interaction, to partial interaction, to distance dependent interaction, to full interaction, gain and noise characteristics can be controlled.

FIG. 3 is a block diagram showing one example of a system 600 operable to generate one or more time modulated pump signals. System 600 includes a pump assembly 614 operable to generate a plurality of non-modulated pump signals 617a-617n, each having a center wavelength λ. In this example, pump assembly 614 includes a plurality of optical sources 614a-614n. Each optical source 614a-614n could comprise, for example, a semiconductor laser diode or other light sources operable to generate optical signals at suitable pump power levels. In the illustrated embodiment, each light source 614a-614n generates one non-modulated pump signal 617. In another embodiment, one or more optical sources could each generate a plurality of pump signals 617. For example, pump assembly 614 could comprise a continuum source.

In this particular example, each light source 614a-614n comprises a fixed wavelength laser operable to generate a pump signal 617 having a particular center wavelength. Throughout this document, the term “fixed wavelength laser” denotes an optical source operable to generate optical signals having a spectral distribution around a fixed wavelength, and which does not during operation perform selective adjustment of the output center wavelength. Transmitters whose output center wavelength varies during operation due to, for example, fluctuations in environmental conditions are not intended to be excluded from the scope of a “fixed wavelength” transmitter. Moreover, wavelength tunable transmitters operated without intentionally selectively varying the output center wavelength of the transmitter during operation are intended to be within the scope of a “fixed wavelength” transmitter. In other embodiments, one or more of optical sources 614a-614n could comprise wavelength tunable optical sources operable to generate optical signals at selectable wavelengths.

System 600 further comprises a plurality of modulators 619a-619n, each operable to receive one of non-modulated pump signals 617. In this particular example, modulators 619 comprise external modulators, such as lithium niobate modulators, electro-absorption based modulators or other external modulator type. Alternatively, modulators 619 could comprise variable attenuators, such as amplitude modulators.

Modulators 619 operate, under the direction of control signals 630 from a controller 621, to selectively modulate non-modulated pump signals 617 to form time modulated pump signals 618. Although this example shows all pump signals comprising time modulated pump signals, one or more pump signals could remain non-modulated.

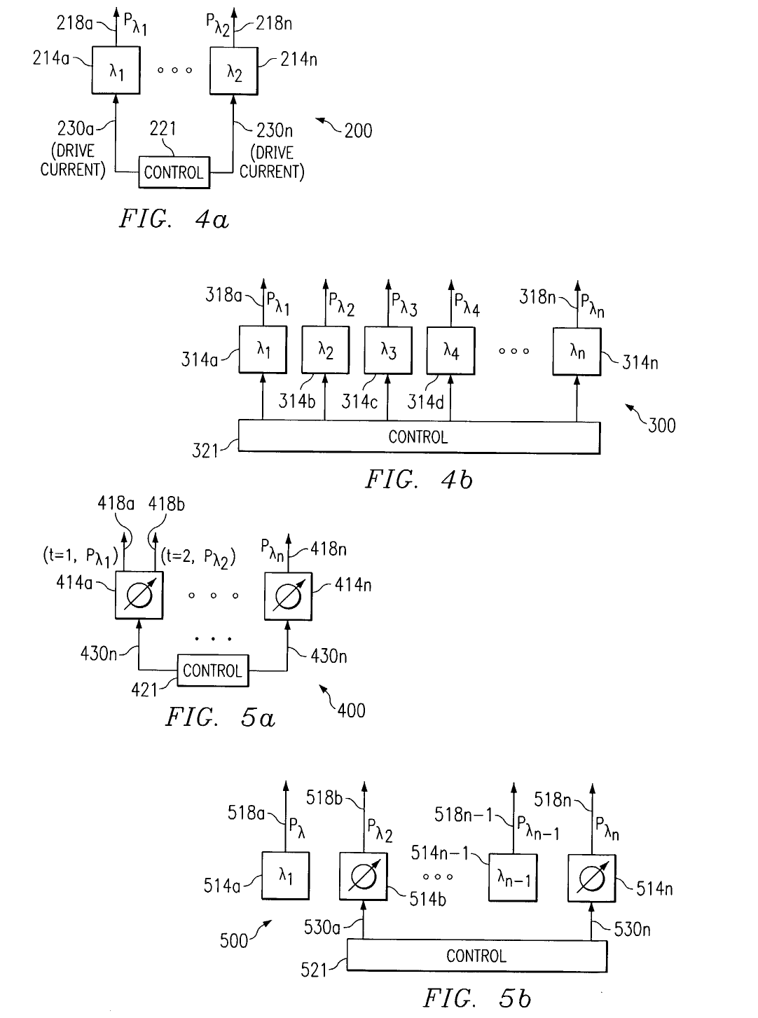

FIGS. 4a-4b are block diagrams showing additional example embodiments of pump assemblies operable to generate one or more time modulated pump signals. In particular, FIG. 4a shows a block diagram of a system 200 operable to generate a plurality of time-modulated pump signals 218a-218n by controlling a drive current to and/or a temperature of optical sources 214 generating those signals. System 200 includes a plurality of optical sources 214a-214n. In this example, each optical source 214 comprises a fixed wavelength laser operable to generate a pump signal 218 having a particular center wavelength.

The output power of each semiconductor laser 214 depends at least in part on a drive current supplied to and/or a temperature of the semiconductor laser. Pump lasers in conventional systems are typically operated in either a completely on state or a completely off state. In this example, controller 221 generates control signals that affect the drive current and/or the temperature of laser diodes 214. In this manner, the laser drive current can be used to modulate the output power of laser diode 214 between a minimum power level and a maximum power level.

Resulting pump signals 218 can comprise any waveform. For example, pump signals 218 could comprise square waves, sinusoidal waves, triangle waves, or any other desired waveform. To ensure consistent continuing operation, it can be advantageous to implement periodic waveforms. Non-periodic waveforms could, however, be used if desired.

In operation, control module 221 generates a plurality of control signals 230a-230n. Control signals 230a-230n could comprise the drive current supplied to laser diodes 214, or could comprise control signals operable to affect an intermediate device supplying the actual drive current to laser diodes 214. In still other embodiments, control signals 230 could comprise signals operable to affect a change in temperature of the laser diodes 214. Control signals 230 modulate laser diodes 214 to result in output pump signals 218 that vary between maximum power levels and minimum power levels.

In some cases, the minimum power levels of pump signals 218 can comprise a zero power level. In at least some designs, it can be desirable to maintain a non-zero minimum pump power level during operation. For example, fiber grating optical feedback used to stabilize and control the output wavelengths from some laser diode designs typically requires time to stabilize to an output wavelength upon application of power from the zero power state. Maintaining a non-zero minimum pump power level during operation avoids temporary destabilization of the output wavelength from laser diodes 214 upon a transition from a minimum power level to a maximum power level.

FIG. 4b is a block diagram of another embodiment of a system 300 for generating at least some time-modulated pump signals. Like the example shown in FIG. 4a, system 300 includes a plurality of light sources 314a-314n, each generating a pump signal 318a-318n, respectively. In this example, however, some pumps (e.g., 314a, 314c, 314d, and 314n) generate time modulated pump signals, while other pumps (e.g., 314b) generate non-modulated pump signals. As a result, particular wavelengths of pump signals 318 provide non-modulated pump power, while others of pump signals 318 deliver varying levels of power as they traverse the gain medium.

In one embodiment, the wavelengths and/or power of pump signals 318a-318n can be selected to directly provide gain to at least a portion of a multiple wavelength signal being amplified. In other embodiments, one or more of pump signals 318 can be selected at a wavelength and/or a power that, although insufficient to directly provide significant gain to any wavelengths of signal 16, can provide energy to other pump signals 318 through Raman transfer. In this manner, some pump signals 318 can be thought of as sacrificial pump signals, which provide little or no direct gain to signals traversing the gain medium, but which provide an energy source for other pump signals 318 amplifying signals traversing the gain medium.

As a particular example, pump wavelengths 318a and 318b may reside at wavelengths sufficiently below the spectrum of signals being amplified so that pump signals 318a and 318b are incapable of providing significant gain to any portion of the amplified signal. For example, each of pump signals 318a and 318b may not be capable of providing more than three decibels of gain to the wavelengths of the signal being amplified. In another example, each of pump signals 318a and 318b may not be capable of providing more than six decibels of gain per Watt of pump power.

However, pump signal 318c could be selected to have a wavelength sufficiently close to at least some wavelengths being amplified to provide significant Raman gain to at least some of those wavelengths. Pump signal 318c could comprise a longer wavelength than the wavelengths of pump signals 318a and 318b, but be sufficiently spaced from the wavelengths of signals 318a and 318b to facilitate Raman transfer from pump signals 318a and 318b to pump signal 318c. This transfer could occur in a step-wise fashion, where power is first transferred from pump signal 318a to pump signal 318b, and then transferred from pump signal 318b to pump signal 318c. Although pump signals 318a and 318b are not capable of significantly amplifying the multiple wavelength signal traversing the gain medium directly, they contribute to amplification by supplying energy to amplifying pump signal 318c through Raman transfer.

By selectively time modulating at least one of pump signals 318a, 318b, and/or 318c and properly accounting for dispersion of the gain medium, the level of interaction among these pump signals can be controlled to control the amount of energy transfer between those signals as a function of position within the gain medium.

FIGS. 5a-5b are block diagrams showing example configurations of systems operable to generate one or more time-modulated pump signals using one or more tunable wavelength optical sources. System 400 shown in FIG. 5a comprises a plurality of tunable wavelength optical sources 414a-414n, each operable to generate a pump signal 418. Tunable wavelength optical sources 414a-414n could comprise, for example, tunable semiconductor lasers or a continuum source followed by a plurality of tunable filters. System 400 includes a controller 421. Controller 421 generates control signals 430, which facilitate tuning pumps 414 to output appropriate wavelength pump signals. Control signals 430 can also control the power modulation of one or more pump signals 418.

Using tunable wavelength optical sources to generate pump signals can be useful, for example, in part sparing, where one tunable laser can be used to replace any of several pump sources to generate pump signals at a particular wavelength. Moreover, using tunable pump sources, it is possible to use a single pump source to generate multiple time modulated pump signals 418. For example, at time t₁, one tunable laser pump 414a could generate a non-zero power portion of a first modulated pump signal 418a having a first wavelength. The same tunable laser pump 414a could then retune to a second wavelength and generate at time t₂ a non-zero power portion of a second modulated pump signal 418b at the second wavelength. This could be desirable, for example, where two time modulated pump signals 418a and 418b do not overlap in time with each other, but may overlap in time with other pump signals 418n. In that case, a plurality n of pump signal wavelengths can be generated using fewer than n tunable laser sources.

FIG. 5b is a block diagram of a system 500 implementing a combination of tunable wavelength pump sources and fixed wavelength pump sources. Producing tunable wavelength pump lasers capable of generating sufficient power to provide desired amplification can be challenging and expensive. System 500 illustrates the use of fixed wavelength pump lasers 514a and 514n-l to augment the operation of tunable wavelength laser pumps 514b and 514n. In this embodiment, lower power tunable lasers can be used to generate pump signals 518b and 518n having longer wavelengths than higher powered pump signals 518a and 518n-l generated by higher powered fixed wavelength pumps. The lower power pump signals 518b and 518n generated by tunable lasers 514b and 514n can accept Raman energy transfer from the higher powered pump signals 518a and 518n-l, respectively.

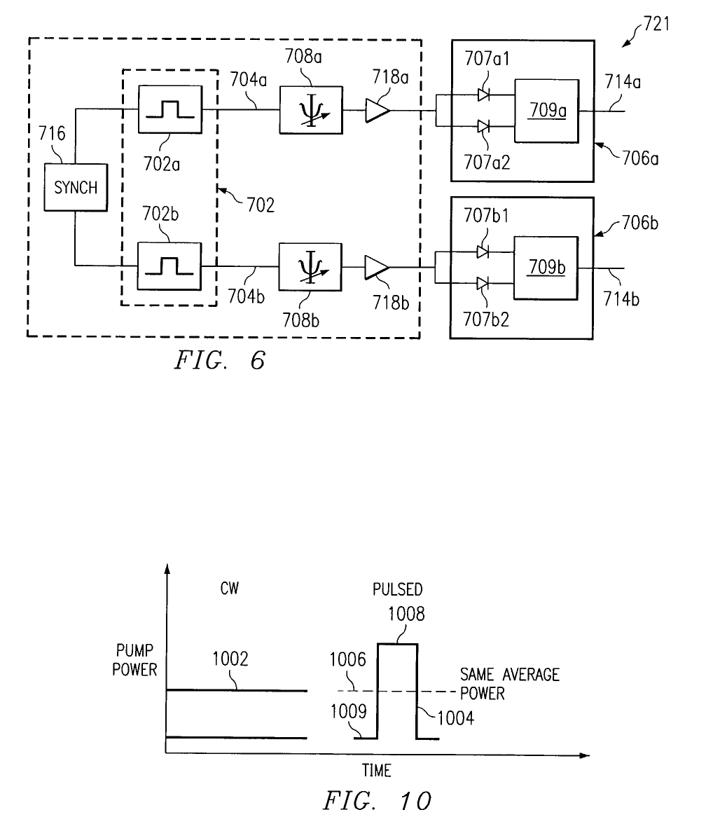

FIG. 6 is a block diagram of an example embodiment of a controller 721 for a pump assembly 706. Controller 721 provides one example of a mechanism useful in controlling the relative phase between a plurality of time modulated pump signals. In this example, controller 721 includes a modulator assembly 702 operable to generate one or more electronic time modulated waveforms 704a and 704b. Modulator assembly 702 could comprise a single modulator operable to generate a plurality of electronic waveforms 704 or could comprise a plurality of separate modulators each operable to generate one electronic waveform 704. In this particular embodiment, modulator assembly 702 includes a first modulator 702a and a second modulator 702b.

Electronic waveforms 704a and 704b are applied to pump assemblies 706a and 706b, respectively. In some embodiments, controller 721 can include electronic amplifiers 718 operable to amplify waveforms 704 prior to application to pump assemblies 706.

Pump assemblies 706 generate optical pump signals 714a and 714b based at least in part on electronic waveforms 704 received. In this particular embodiment, each pump assembly 706 comprises a polarization multiplexed pump assembly. Other optical generating mechanisms could alternatively be used.

In this particular example, each polarization multiplexed pump assembly 706a-706b includes a pair of light sources 707a1-707a2 and 707b1-707b2, respectively. Each light source operates to generate an optical beam having a polarization approximately orthogonal to the beam generated by the other. The orthogonally polarized beams generated by light sources 707 are combined by polarization multiplexers 709a and 709b, respectively. Implementing polarization multiplexed pump signals provides advantages of increasing the power of each pump signal wavelength using relatively lower powered pumps. In addition, implementing polarization multiplexed pump signals reduces gain polarization dependencies.

In this particular example, controller 721 includes a synchronizer 716 operable to synchronize waveforms 704a and 704b. Although this example shows one synchronizer operating on all time modulated pump signals, separate synchronizers could be used for one or more time modulated pump signals.

Controller 721 also comprises one or more phase shifters 708a-708b, each operable to selectively alter the phase of a waveform received. The phase shifters shown here could be implemented, for example, with analog components, or could be implemented with digital components. For example, modulators 702 and phase shifters 708 could be implemented with a high speed clocking source driving a memory register for each pump signal. Bits could be output from the register at a rate that is an integer multiple of the desired repetition frequency of the resulting optical signal waveform. In that embodiment, the relative phase of each signal could be controlled, for example, by shifting the pattern of the bits that are spilled from each register with respect to the other registers. The memory registers could comprise one or more physical memory chips.

In this particular example, phase shifters 708 shift the phase of electronic signals received. Alternatively, phase shifters 708 could receive optical signals 714 and shift the phase of optical signals received. Regardless of the position of phase shifters 708 and whether they operate on electronic or optical waveforms, phase shifters 708 provide one mechanism of selectively controlling the relative phase of the time modulated pump signals. This feature provides just one example of a characteristic that can be used to control the amount of interaction between pump signals and, therefore, control the gain of the amplifier stage and/or its noise figure.

Although this particular example shows the use of two time modulated signals, any additional number of time modulated signals and apparatus associated with those signals could be implemented.

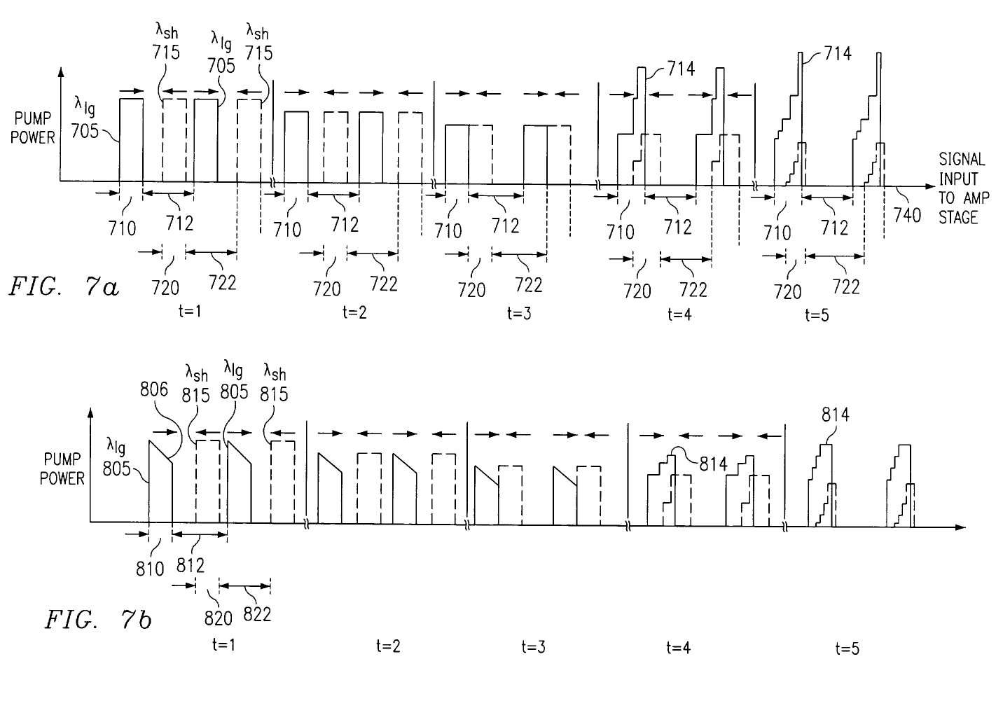

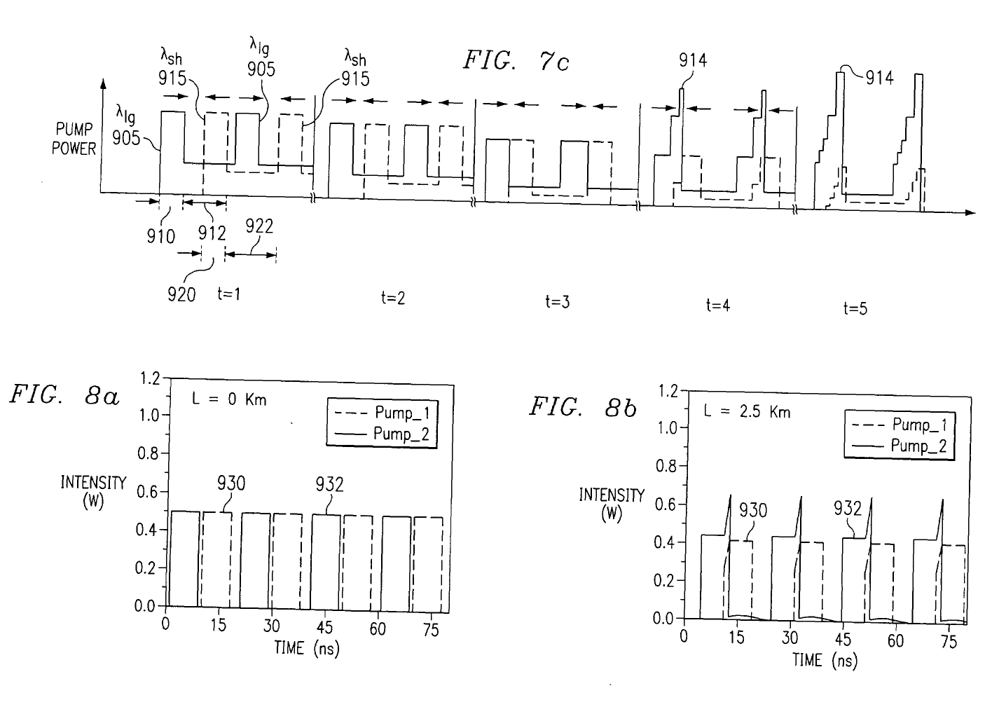

FIGS. 7a-7c are timing diagrams showing example interactions between time modulated pump signals in Raman amplification stages. FIG. 7a depicts two time modulated pump signals 705 and 715 as those signals travel through a gain medium 740 in a Raman amplification stage. The example shown here increases the reach of the pump signals through the gain medium by controlling various characteristics of the modulation waveforms to control the amount of interaction between pump signals. By increasing the reach of the pump signals, this example reduces the noise figure of the system.

The amount of gain that can be usefully imparted in a Raman amplification stage is generally limited by double Rayleigh scattering or other types of multi-path interference. As a result, for a given maximum usable gain, it is desirable to control when and where gain is applied within the gain medium. This can be particularly true in a distributed Raman amplifier, where conventional designs experience difficulties in having counter-propagating pump signals penetrate deep into the gain medium without using very high pump launch powers.

As a particular example, it may be desirable to use one or more counter-propagating pumps to impart a significant portion of the gain as close to the signal input end of the gain medium as possible. This facilitates amplifying the multiple wavelength signal prior to that signal experiencing all of the losses it will incur as it traverses the gain medium. This can result in a lower noise figure over at least a portion of the gain spectrum of the amplifier stage. In particular, this can result in a lower noise figure than would be experienced if the same pump signals were launched as non-modulated pump signals.

In the illustrated example, each time modulated pump signal 705, 715 comprises a higher power portion 710, 720 and a lower power portion 712, 722, respectively. In this example, each pump signal 705 and 715 periodically modulates between the higher power portion and the lower power portion of the signal. Although this example depicts an approximate square wave time modulated pump signal, any modulated pump signal waveform format could be used.

The illustrated embodiment assumes that first time modulated pump signal 705 comprises a longer wavelength than second time modulated pump signal 715. This example also assumes that the dispersion characteristics of gain medium 740 result in first pump signal 705 having a lower group velocity than second pump signal 715 through gain medium 740.

As shown in FIG. 7a, first and second time modulated pump signals 705 and 715 are initially launched so that the higher power portions of those signals do not overlap in time. Because in this example, lower power portions 712 and 722 of signals 705 and 715 comprise zero power, there is no signal-signal interaction between signals 705 and 715 while higher power portions 710 and 720 of those signals do not overlap in time.

In this example, higher power portions 710 and 720 of first and second time modulated pump signals 705 and 715 do not overlap in time until time t₄. At time t₄, longer wavelength first pump signal 705 begins to accept energy from shorter wavelength second pump signal 715. As a result, the peak power 714 of first pump signal 705 increases. As pump signals 705 and 715 continue to traverse gain medium 740 at time t₅, the amount of time that higher power portions of 710 and 720 overlap increases, and the opportunity for Raman energy transfer from shorter wavelength pump signal 715 to longer wavelength pump signal 705 likewise increases. The increased interaction further increases the peak power 714 of longer wavelength pump signal 705.

In addition to controlling the relative phase of the time modulated pump signals, other waveform characteristics could be used to control the amount of interaction between pump signals. For example, the modulation repetition rates, the wavelength separation between pump signals, the relative peak powers of the pump signals, the duty cycles, and/or the extinction ratios of the pump signals provide just a few examples of characteristics that can be controlled to affect the amount and timing of interaction between pump signals.

The configuration shown in FIG. 7a shows one example of a mechanism for controlling pump-pump interactions to selectively apply gain at particular levels in particular locations along the gain medium. In this example, significant gain is applied further along gain medium 740 than would be possible if no pump signals were time modulated. In this manner, the noise figure of the amplifier stage is reduced by imparting gain to optical signals closer to the input end of the gain medium.

FIG. 7b provides another example of controlled interaction between pump signals in a Raman amplification stage. The example shown in FIG. 7b is similar to the example shown in FIG. 7a, except that in this case, first time modulated pump signal 805 comprises a more gradual transition 806 between a higher power portion 810 and a lower power portion 812. The gradual transition 806 is selected to reside at least on the edge of pump signal 805 that will initially interface another pump signal that will transfer energy to signal 805. Implementing a gradual transition between a higher power portion and a lower power portion of pump signal 805 facilitates broadening the time period over which the maximum power of pump signal 805 occurs when interacting with other pump signals.

In this example, higher power portions 810 and 820 of first and second time modulated pump signals 805 and 815 do not overlap in time until time t₄. At time t₄, longer wavelength first pump signal 805 begins to accept energy from shorter wavelength second pump signal 815. As a result, the peak power 814 of first pump signal 805 increases. However, the gradual transition 806 between lower power portion 812 and higher power portion 810 broadens the time period over which the increased power of pump 805 is applied, compared to that time period in FIG. 7a.

FIG. 7c provides yet another example of controlled interaction between pump signals in a Raman amplification stage. The example shown in FIG. 7c is similar to the example shown in FIG. 7a, except that in this case, first time modulated pump signal 905 and second modulated pump signal 915 each comprise a non-zero lower power portion 912 and 922, respectively. For ease of illustration this example depicts only interaction between higher power portions of pump signals 905 and 915, and does not show interaction that likely would occur between non-zero minimum power portions of those signals.

In this example, higher power portions 910 and 920 of first and second time modulated pump signals 905 and 915 do not overlap in time until time t₄. At time t₄, higher power portion 910 of longer wavelength first pump signal 905 begins to accept energy from higher power portion of shorter wavelength second pump signal 915. As a result, the peak power 914 of first pump signal 905 increases.

In the illustrated embodiment, lower power portions 912 and 922 of pump signals 905 and 915, respectively, are maintained at non-zero power levels during operation. As a particular embodiment, lower power portions 912 and 922 are maintained at power levels comprising at least five percent (5%) of the maximum launched power of the respective pump signal. Maintaining a non-zero pump power at all times during operation provides an advantage of reducing problems caused when fiber grating optical feedback associated with some pump designs loses wavelength lock and undergoes a period of wavelength instability while attempting to regain wavelength lock.

Although the examples described with respect to FIGS. 7a-7c have shown just two pump signals any number of pump signals can be utilized. Moreover, although these examples show all pump signals being time modulated, any number of non-modulated pump signals could also be used.

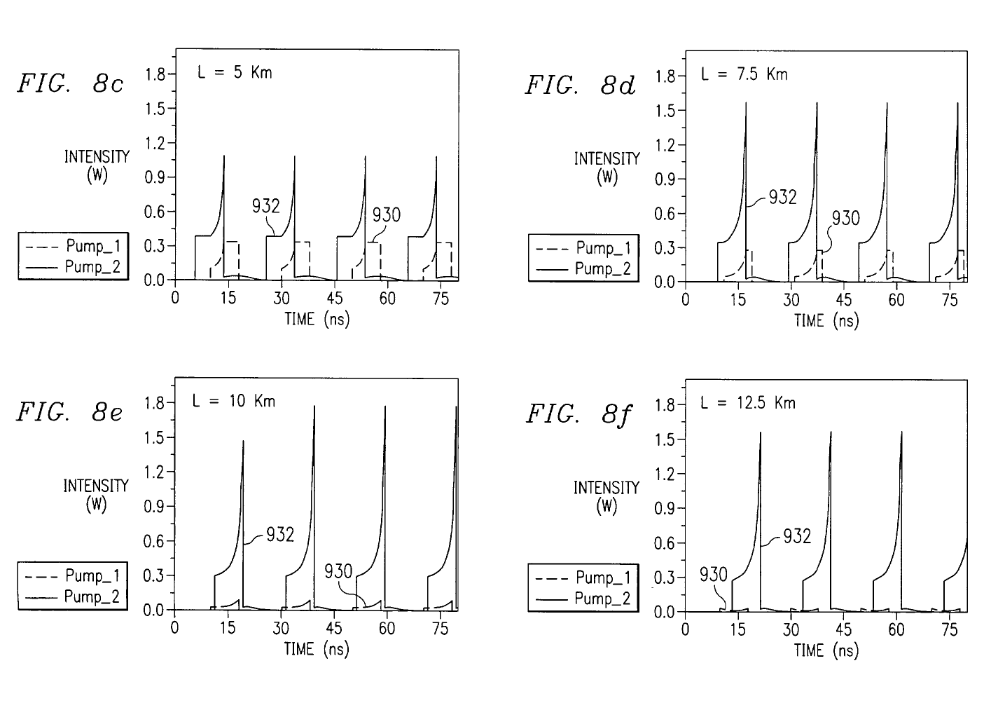

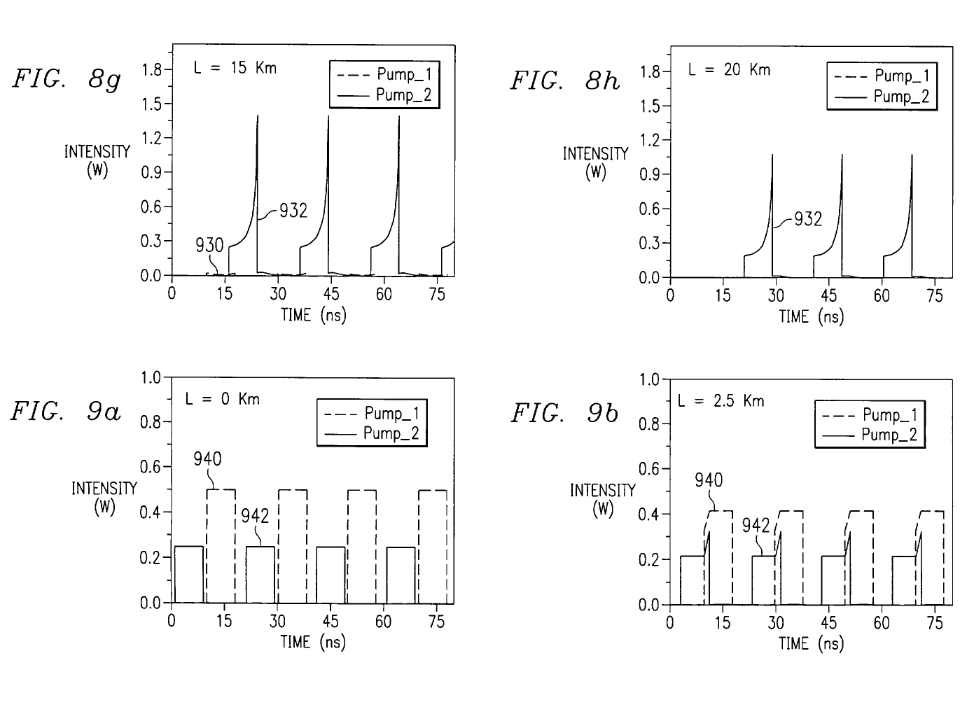

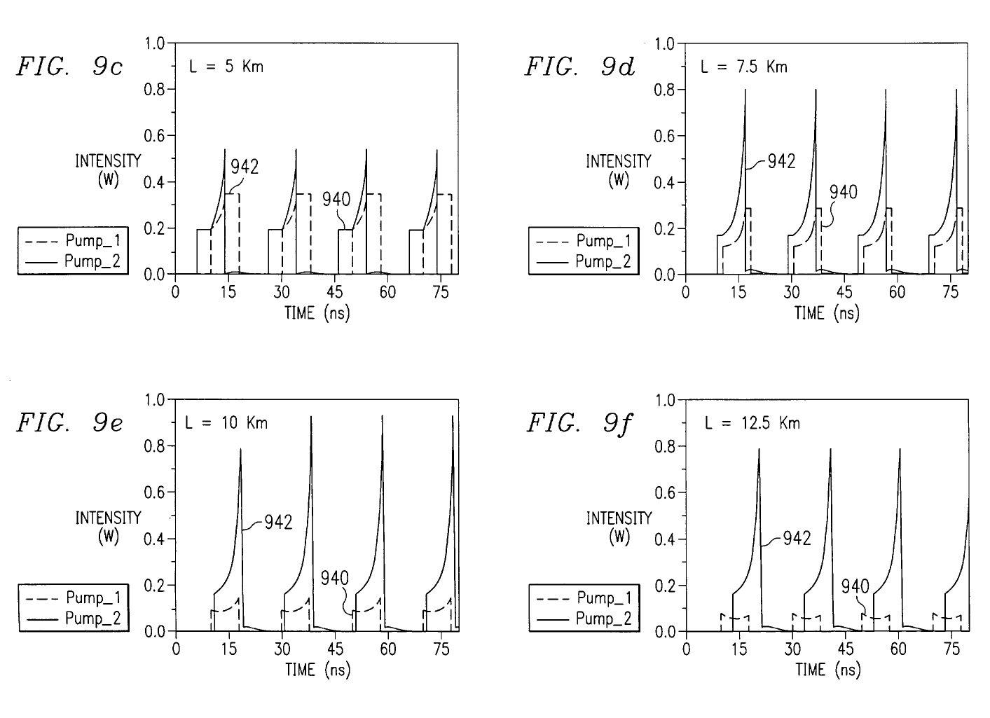

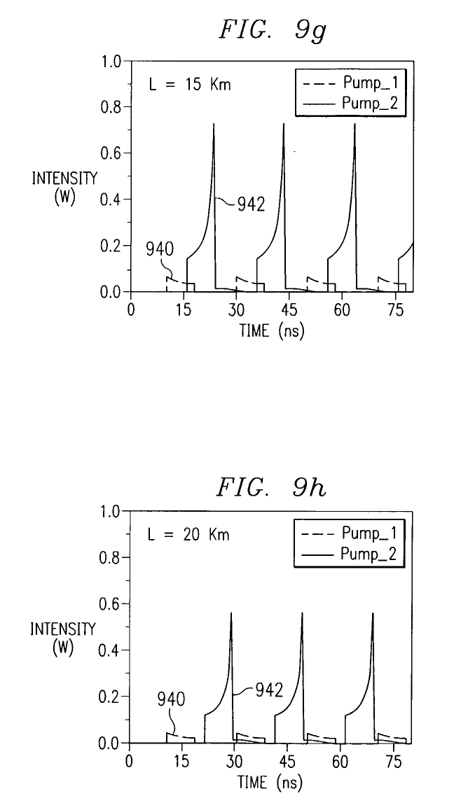

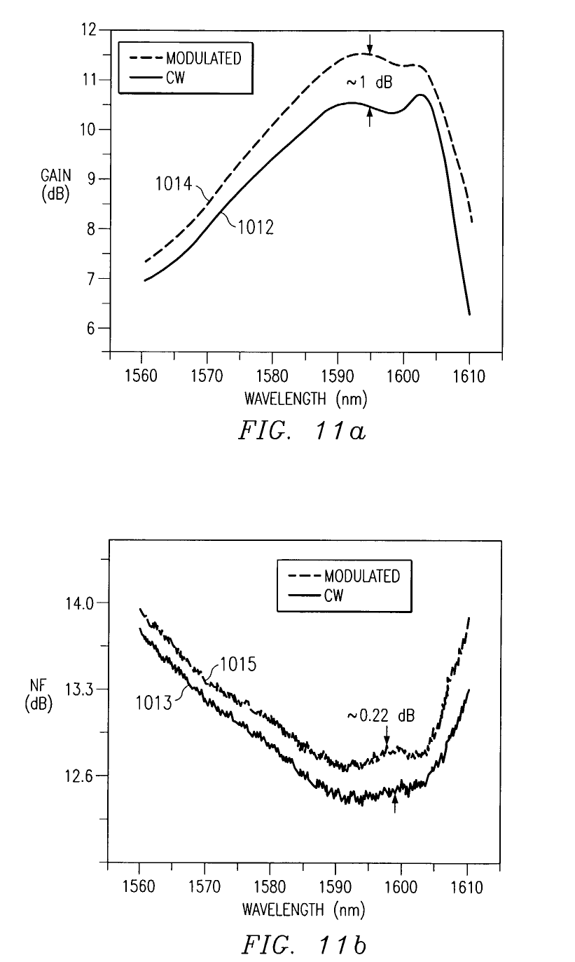

FIGS. 8 and 9 are graphical illustrations of simulated pump-pump interactions similar to those depicted in FIGS. 7a-7c. Both cases assumed a single mode fiber having a length of approximately twenty kilometers, a dispersion of 10 ps/nm*km and a dispersion slope of 0.07 ps/nm\hat{ }2*km. Each simulation implemented two time modulated pump signals modulated at 50 Megahertz with a duty cycle of 30 percent.

FIGS. 8a-8h depict simulations of interaction between two time modulated pump signals, a first pump signal 930 having a center wavelength of 1400 nanometers, a second pump signal 932 having a center wavelength of 1490 nanometers. In this example, each pump signal comprises a maximum power of 500 milli-watts and a minimum power of approximately 5 percent of the peak pump power. In this case, second pump signal 932 is launched approximately 10 nanoseconds prior to the launch of first pump signal 930, so that initially, the two signals do not overlap.

As illustrated in these figures, second (longer wavelength) pump signal 932 travels slower along the gain medium than first (shorter wavelength) pump signal 930. Eventually, (see, e.g., FIG. 8b), the longer wavelength pump signal 932 begins to overlap in time with shorter wavelength pump signal 930. At that point, longer wavelength pump signal 920 begins to accept energy from shorter wavelength pump signal 930. As those signals continue to traverse the gain medium, longer wavelength pump signal 932 continues to walk through shorter wavelength pump signal 930, accepting more and more energy from that pump signal. In this example, shorter wavelength pump signal eventually surrenders all of its energy to longer wavelength pump signal 932.

FIGS. 9a-9h depict similar simulations of interaction between two time modulated pump signals, a first pump signal 940 having a center wavelength of 1400 nanometers, a second pump signal 942 having a center wavelength of 1490 nanometers. In this example, first pump signal 940 comprises a maximum power of 500 milli-watts, while second pump signal 932 comprises a maximum power of 250 milli-watts. Each signal comprises a minimum power of approximately 5 percent of the peak pump power. In this case, longer wavelength pump signal 942 is launched approximately 10 nanoseconds prior to the launch of shorter wavelength pump signal 940, so that initially, the two signals do not overlap.

As illustrated in these figures, longer wavelength pump signal 942 travels slower along the gain medium than shorter wavelength pump signal 940. Eventually, (see, e.g., FIG. 9b), longer wavelength pump signal 942 begins to overlap in time with shorter wavelength pump signal 940 and accepts energy from shorter wavelength pump signal 940. As those signals continue to traverse the gain medium, longer wavelength pump signal 942 continues to walk through shorter wavelength pump signal 940, accepting more and more energy from that pump signal.

This example leverages the fact that longer wavelength pump signal 942 will be accepting energy from shorter wavelength pump signal 940, to reduce the pump power used for longer wavelength pump signal 942.

The examples in FIGS. 7-9 show, among other things, how controlling pump interactions can reduce the noise figure of an amplifier by increasing the reach of the pump signals in the gain medium, particularly for counter-propagating pump signals. As discussed above, time modulated pump signals can also be used to enhance interaction between pump signals, resulting in increased gain and a corresponding reduction in noise figure for a given average pump power. Although the examples discussed with reference to FIGS. 7-9 illustrate interaction of just two time modulated pump signals, similar concepts apply to interaction of any number of time modulated pump wavelength signals.

The gain of an amplifier stage depends in large part on the launch power of the pump signals. In equation form the gain (G) of an amplifier stage can be expressed as:

G=exp(gᵣ P_{Launch} Z_{eff}/A_{eff}−αz)

where, gᵣ is the Raman gain coefficient of the gain fiber used in the amplifier stage; P_{Launch} is the pump power launched into the fiber; Z_{eff} is the effective fiber length; A_{eff} is the effective fiber area; α is the fiber loss; and z is the actual fiber length.

Furthermore, the noise figure of the amplifier varies as a function of the amplifier gain and the ASE power. In equation form, the noise figure for an amplifier stage (NF) can be expressed as:

NF=1/G((P_{ASE}/hνB₀)+1))

where G is the gain of the amplifier stage; P_{ASE} is the power of the ASE signal, h is Plank's constant, ν is the frequency; and B₀ is the bandwidth over which the ASE signals are measured.

In addition, the power of the ASE signals varies as a function of the amplifier gain and the details of the amplifier design. In equation form, the power of the ASE signals can be expressed as:

P_{ASE}=2 hνB₀×(G(ν)−1)×nₛₚ(G(ν))

where h is Plank's constant, ν is the frequency, B₀ is the bandwidth over which the ASE signals are measured, and G is the gain of the amplifier stage. In this case, nₛₚ is a function that depends on the details of the amplifier design such as ASE signal amplification and/or attenuation as a function of position.

Ignoring the gain dependence of nₛₚ, the power of the ASE signals of an unsaturated time modulated pump signal having a fixed spectrum and a square modulation waveform can be compared to the power of the ASE signals of a non-modulated pump signal. In equation form, this relationship can be expressed as:

P_{ASE-MOD}−P_{ASE-CW}=(DC×(G_{MAX}−1)+(1−DC)×(G_{MIN}−1))÷(G−1)

where DC is the modulation duty cycle (fraction of time the ASE level corresponds to G_{MAX}), G_{MAX} is the gain corresponding to the higher pump power portion of the modulated waveform, G_{MIN} is the low pump power gain, P_{ASE-MOD} is the time-averages ASE level generated by the time modulated waveform, and P_{ASE-CW} and G are the ASE level and gain generated by a non-modulated source having the same average power as the modulated source. In this equation, G_{MAX} and G_{MIN} can be determined by the following equations:

G_{MIN}=G^{{}1÷(DC×(ER−1)+1)}

G_{MAX}=G^{{}ER÷(DC×(ER−1)+1)}

where G is the gain generated by a non-modulated source having the same average power as the modulated source, ER is the extinction ratio of the modulated waveform (e.g., P_{MAX}÷P_{MIN}), and DC is the modulation duty cycle.

The larger the peak pump power, the larger the gain of the amplifier stage. Moreover, in most cases with a relatively high modulation repetition rate, and up to a certain point, the higher the gain of the amplifier, the lower the noise figure of the amplifier. By implementing time modulated pump signals having a large peak power relative to the pump's average power and having optimized waveform characteristics to control the relative power of the ASE signals, the amplifier stage can experience increased gain and a lower noise figure for a given average power.

FIG. 10 is a portion of a timing diagram showing portions of a continuous wave (CW) pump signal 1002 and a time modulated pump signal 1004. In this example, CW pump signal 1002 and time modulated pump signal 1004 comprise an equal average power 1006. Using the same average pump power, however, time modulated pump signal 1004 can achieve a higher peak power 1008. In this example, time modulated pump signal 1004 comprises a zero power minimum power level 1009. In other embodiments, minimum power level 1009 could comprise a non-zero power level.

FIG. 10 illustrates how time modulated pump signals can provide increased peak powers using the same average power as a CW light source. If desired, the higher peak power time modulated pump signals can be generated using pumps rated for much lower CW powers. For example, in one particular embodiment, time modulated pump signal 1004 can be generated by driving a light source beyond its rated CW power capacity. Because time modulated pump signal 1004 cycles the light source between maximum power level 1008 and minimum power level 1009, the light source can be driven beyond its rated CW power capacity without damaging the component. Although the maximum power level 1008 can exceed the rated CW power capacity of the light source, the average power of the time modulated pump signal 1004 should remain below the rated CW power capacity of the light source to avoid damaging the component. Through appropriate choice of, for example, repetition rate, duty cycle, and peak power level of time modulated pump signal 1004, various levels of power can be supplied beyond the rated CW power of the light source without risking damage to the source. Increasing the peak power of the time modulated pump signal using a given average pump power can provide an advantage of increasing the gain of the amplifier for that given average pump power.

Furthermore, using appropriate modulation techniques, time modulated pump signals can be generated, which have a higher peak power than the average power output by the light source generating those signals. For example, time modulated pump signals can be generated by varying the intensity of light produced by the light sources (rather than modulating a CW light source after it has been generated). In that way, the time modulated pump signals can provide a higher peak power than the rated average power of the light source. Providing a high peak power increases the gain of the amplifier stage. In most cases, the high peak power and the comparatively lower average power provide a reduced noise figure for the amplifier stage. In some cases, however, particularly at relatively low modulation repetition rates, a high peak power with a comparatively low average power can increase the magnitude of the ASE signals co-propagating with the time modulated pump signals, potentially resulting in a degraded noise figure. Using appropriate modulation techniques, system designer's can counter this increase by manipulating and/or optimizing one or more waveform characteristics of the time modulated pump signals to achieve a desired gain level and an acceptable noise figure.

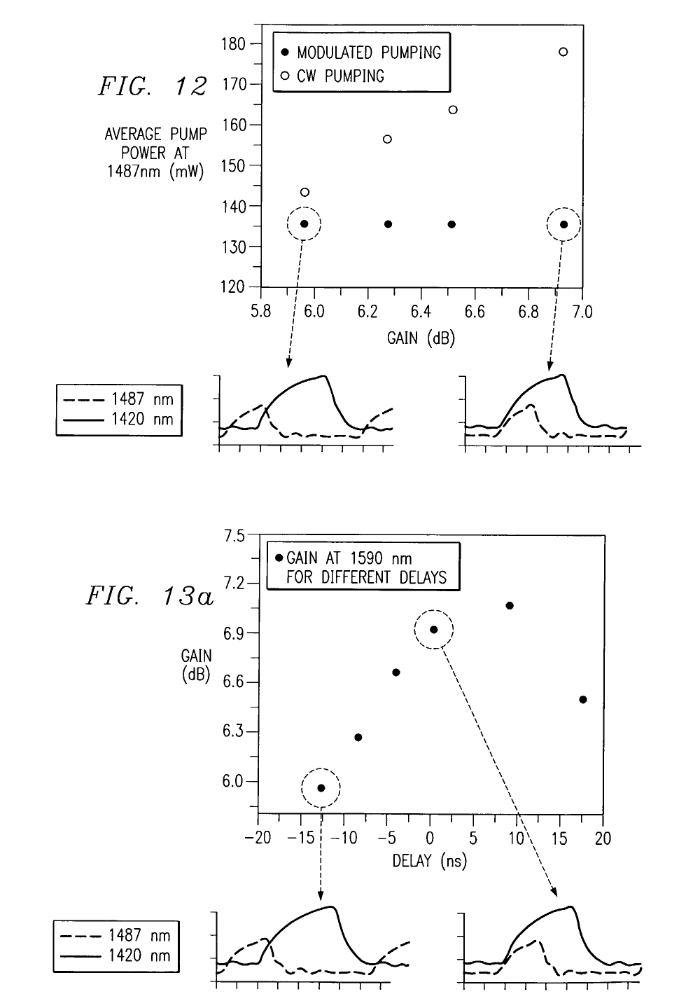

FIGS. 11a and 11b are graphs illustrating experimental results showing improvements in gain and noise figures for an amplifier stage using time modulated pump signals compared to the same amplifier using CW pump signals. This experiment involved a single stage distributed Raman amplifier comprising a gain medium of approximately sixty-one (61) kilometers of SMF-28 fiber pumped by two pump signals. One pump signal was generated at a wavelength of 1420 nanometers, the other at a wavelength of 1487 nanometers. The 1420 nanometer pump signal had an average pump power of 356 milli-watts while the 1487 nanometer pump signal had an average power of 300 milli-watts.

In one case (gain curve 1012 and noise figure curve 1015), both pump signals comprised CW signals. In the other case (gain curve 1014 and noise FIG. 1013), both pump signals were modulated at a rate of fifteen megahertz, and both pump signals used an extinction ratio of approximately 5:1. The 1420 nanometer pump signal had a duty cycle of forty percent (40%), while the 1487 nanometer pump signal had a duty cycle of thirty percent (30%). The time modulated pump signals had peak powers of 700 milli-watts and 740 milli-watts, respectively. The phase of the pump signals was chosen so that the higher power portions of each signal initially substantially overlapped.

As shown in FIG. 11a, using time modulated pump signals with the same average power as the CW pump signals, but higher peak powers than the CW pump signals, the time modulated embodiment was able to achieve a higher gain and a lower noise figure. In this particular experiment, the time modulated embodiment realized a gain increase of approximately one decibel and a noise figure decrease of approximately 0.22 decibels over the CW embodiment.

Note that the waveform characteristics, pump powers, gain fiber, etc. were chosen arbitrarily in this experiment. Moreover, the gain fiber used was particularly lossy compared to other available alternatives. This disclosure is not intended to be limited to the particular results described with respect to this experiment. By varying the waveform characteristics, the pump powers, fiber type, etc., other levels of gain and/or noise figure enhancement could be obtained.

FIG. 12 is a graph comparing operation of an amplifier stage driven by CW pumps to the same amplifier stage driven by time modulated pump signals. The physical configuration of the amplifier stage used in this example is the same as that used with respect to FIGS. 11a-11b. In this case, the average pump power in the time modulated embodiment remained constant. This experiment shows the increased average pump power needed in the CW embodiment to achieve the same gain attained in the time modulated embodiment.

In particular, in all cases, the time modulated 1420 nanometer pump signal had an average power of 400 milli-watts, and the time modulated 1487 nanometer pump signal had an average pump power of 135 milli-watts. The 1420 nanometer CW pump was maintained, like the time modulated pump, at 400 milli-watts average power. The 1487 nanometer CW pump was, however, increased in average power to attain the same gain achieved by the time modulated embodiment.

The horizontal axis of FIG. 12 shows the gain attained by each amplifier embodiment, while the vertical axis of FIG. 12 shows the average power used by each 1487 nanometer pump signal. As shown in FIG. 12, to obtain an equivalent gain in the two amplifier embodiments, the 1487 nanometer CW driven pump signal required more average pump power than the time modulated 1487 nanometer pump signal, in some cases over 40 milliwatts more than the time modulated pump signal.

FIG. 12 also shows how the initial relative phases of the time modulated pump signals affect the gain attained. As shown here, in this particular embodiment, the closer the phase of the two time modulated pump signals the higher the gain attained and the greater the savings in average pump power.

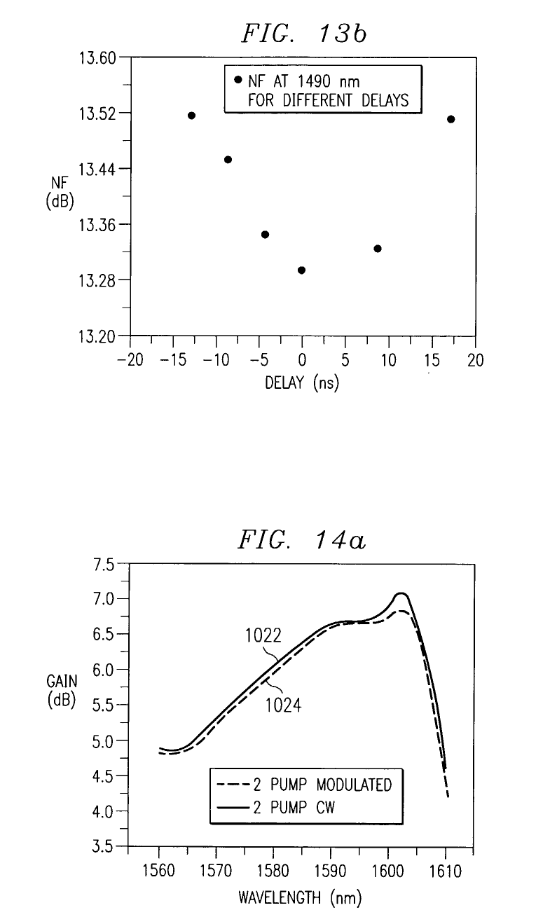

FIGS. 13a and 13b are graphs further illustrating how the initial phase difference between time modulated pump signals can affect the gain and noise figure of an amplifier. This particular example uses the same physical configuration and waveform characteristics as the experiment described with respect to FIG. 12. In this case, the initial phase difference between the 1420 nanometer and the 1487 nanometer pump signal was varied to study resulting gains and noise figures.

As shown in FIG. 13, in this particular configuration, reducing the initial phase difference between time modulated pump signals generally increased the gain achieved and decreased the noise figure of the amplifier stage. Of course, in other embodiments depending on numerous factors, such as, the relative wavelength separation of the pump signals, the relative pump powers used, and the type and length of gain medium used, the maximum gain and minimum noise figure could occur at various levels of phase mismatch. The results shown in FIG. 13 are merely intended to provide one example.

Time modulated pump signals can result in improved noise figures for at least two reasons. First, utilizing time modulated pump signals with higher peak powers can result in increased gain, which generally results in an improved noise figure. Second, the time modulated system can result in a better noise figure by increasing the reach of the pump signals further into the gain medium. At least when using counter-propagating pump signals, extending the reach of the pump signal allows amplification of the optical signals before they experience all losses they will incur. This tends to decrease the noise figure of the amplifier.

FIGS. 14a-14b are graphs comparing experimental results of gain and noise figures, respectively, of an amplifier using CW pump signals to the same amplifier using time modulated pump signals. The experiment reflected here shows how time modulating pump signals can reduce the noise figure of an amplifier stage even where the gain of the amplifier is not increased.

This experiment used the same physical configuration as the experiment described in FIG. 11. In this case, both the CW and the time modulated 1420 nanometer pump signals had an average power of 400 milli-watts. The time modulated 1487 nanometer pump had an average power of 135 milli-watts. The CW 1487 nanometer pump, however, had its average power increased to 179 milli-watts, in order to achieve the same gain as the time modulated embodiment. FIG. 14a shows the gain 1022 of the CW embodiment is approximately equal to or slightly greater than the gain 1024 of the time modulated embodiment.

FIG. 14b shows that using the time modulated embodiment, a reduction in noise figure can be obtained, even where the gains of the two systems are similar. Line 1023 shows the noise figure of the CW embodiment, while line 1025 shows the improved noise figure of the time modulated embodiment. Although this particular example shows a relatively small improvement in noise figure for the time modulated embodiment, it should be recognized that more significant improvements could be obtained. For example, this particular experiment utilized a particularly lossy gain medium and relatively low pump power levels. Increasing the pump powers or using a less lossy gain medium would allow the pump signals to traverse further along the gain medium, further improving the noise figure of the amplifier stage.

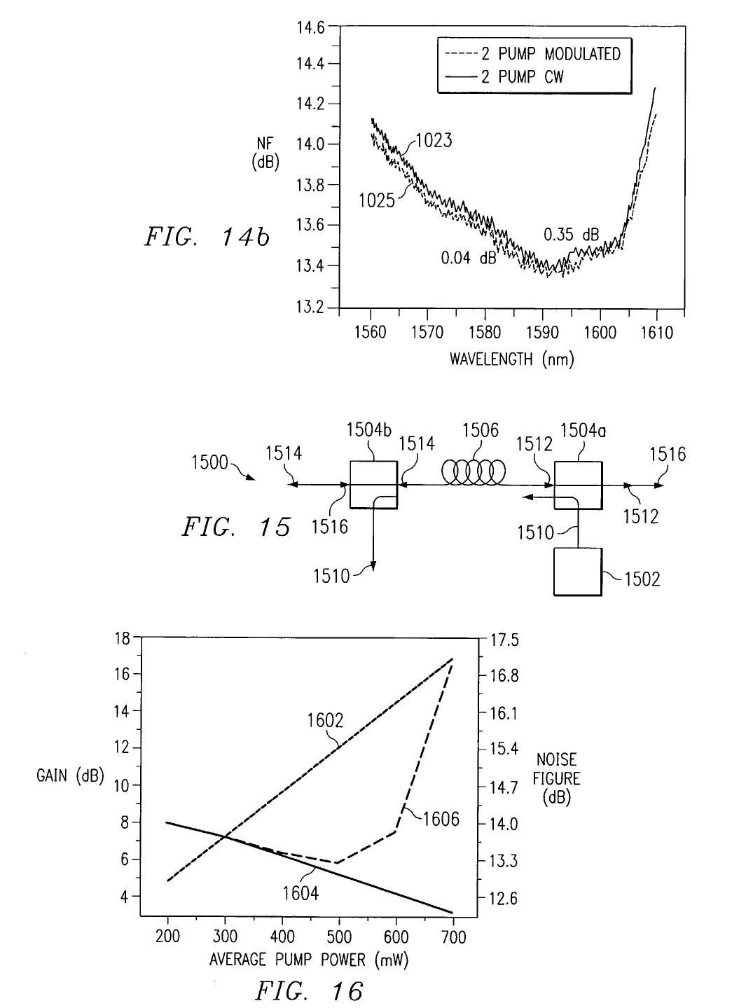

FIG. 15 is a block diagram illustrating one example of an amplification stage 1500 capable of manipulating waveform characteristics to control and/or minimize the effect of ASE signals on a noise figure associated with amplification stage 1500. Amplification stage 1500 can comprise a distributed Raman amplification stage or a discrete Raman amplification stage. In this example, amplification stage 1500 includes a pump source 1502 capable of generating at least one pump signal 1510 having a center wavelength of approximately 1487 nanometers. Pump source 1502 may comprise any device capable of generating pump signal 1510, such as, for example, at least one optical source. In various embodiments, pump source 1502 can be substantially similar to pump assembly 114 of FIG. 2.

In this embodiment, pump signal 1510 comprises at least one time modulated pump signal. The time modulated pump signal can comprise any desired waveform. In this particular embodiment, the time modulated pump signal comprises a modulation repetition rate of approximately one (1) megahertz, a duty cycle of approximately twenty percent (20%), an extinction ratio of approximately 10:1, and an average pump power of approximately 400 milliwatts. In other embodiments, pump signal 1510 can include at least one non-modulated pump signal or a combination of time modulated pump signals and non-modulated pump signals.

Pump signal 1510 amplifies an optical signal 1516 in a gain medium 1506. In various embodiments, gain medium 1506 may comprise a discrete gain fiber or a portion of a fiber span or transmission link. In this particular embodiment, gain medium 1506 comprises approximately sixty-one (61) kilometers of single mode fiber. In other embodiments, at least a portion of gain medium 1506 may comprise a dispersion compensating fiber. Implementing a dispersion compensating fiber as at least a portion of gain medium 1506 is advantageous in enabling dispersion compensation.

In this example, amplification stage 1500 includes at least a pump input coupler 1504a and a pump output coupler 1504b. In an alternative embodiment, amplification stage 1500 can exclude pump output coupler 1504b. Couplers 1504a and 1504b can comprise any device capable of coupling and/or de-coupling pump signal 1510 to and/or from amplification stage 1500. In this particular embodiment, couplers 1504a and 1504b comprise wavelength division multiplexers. Pump input coupler 1504a operates to introduce pump signal 1510 to gain medium 1506 and pump output coupler operates to de-couple pump signal 1510 from gain medium 1506 after amplifying optical signal 1516.

In operation, pump signal 1510 propagates through gain medium 1506 in a direction substantially opposite to the direction that optical signal 1516 propagates in gain medium 1506. In this example, pump signal 1510 operates to generate a co-propagating ASE signal 1514 that traverses gain medium 1506 in substantially the same direction as pump signal 1510. In addition, pump signal 1510 operates to generate a counter-propagating ASE signal 1512 that traverses gain medium 1506 counter to the direction of pump signal 1510. Due to sources that can scatter light propagating in a fiber into the opposite direction, such as, Rayleigh scattering, reflections from components and bad splices, and/or Brillouin scattering, portions of co-propagating ASE signal 1514 are scattered into the direction of optical signal 1516. This scattering of co-propagating ASE signal 1514 thus increases the power level of counter-propagating ASE signal 1512.

In this example, co-propagating ASE signal 1514 can experience a higher time-averaged and/or peak gain than the average gain experienced by optical signal 1516 and/or counter-propagating ASE signal 1512. Because the co-propagating ASE signal 1514 travels through gain medium 1506 in the same direction as pump signal 1510, a portion of the co-propagating ASE will experience the peak power of time modulated pump signal 1510 for a relatively longer duration compared to counter-propagating ASE. In some cases, the relatively longer duration experienced by the co-propagating ASE signal is limited by dispersive walk off. This longer duration can lead to an increase in the average power of co-propagating ASE signal 1514 because of the exponential pump power dependence of the gain. The exponential power dependence leads to that portion of the ASE signal experiencing the peak pump power increasing more than that portion of the ASE signal experiencing the minimum pump power decreases. Without proper amplifier design, this increased co-propagating ASE power level in systems with time modulated pumps can be scattered into the direction of optical signal 1516 and thus degrade the noise figure of the amplifier compared to a CW pumped amplifier.

To control the effects of co-propagating ASE signal 1514 on the noise figure of amplification stage 1500, system designers can manipulate the waveform characteristics of the time modulated pump signal to achieve a desired noise figure and gain. In one embodiment, the modulation repetition rate of the time modulated pump signal can be increased to a sufficiently high level. Increasing the modulation repetition rate tends to increase the walk off, relative to the modulation cycle time, of ASE signal 1514 and pump signal 1510, particularly where there is relatively high dispersion in the gain medium. As a rule of thumb, modulation repetition rates of more than approximately one (1) megahertz start to cause the effects of chromatic dispersion to become significant.

In some cases, achieving a sufficiently high modulation repetition rate may be impracticable. In those cases, other waveform characteristics of the time modulated signal can be selected to control and/or minimize the power level of co-propagating ASE signal 1514. Selecting a duty cycle, an extinction ratio, and/or a peak power of the modulation waveform can control and/or minimize the impact of co-propagating ASE signal 1514 on amplification stage 1500. Using any one or a combination of these characteristics (and possibly other characteristics as well) can enable various degrees of design freedom in controlling and/or minimizing the impact of co-propagating ASE signal 1514 on the noise figure. Alternatively, or in addition, a maximum gain level for the amplifier can be chosen to reduce the adverse effects of the increased co-propagating ASE present in time modulated pumping schemes.

Through the manipulation of the waveform characteristics of time modulated pump signals, system designers can maintain an ASE penalty associated with amplification stage 1500 at or below a desired level. The term “ASE penalty” refers to an increase in the power level of an ASE signal resulting from and co-propagating with a time modulated pump signal when compared to the power level of an ASE signal generated by a non-modulated pump signal. In some embodiments, amplification stage 1500 can have an ASE penalty of fifteen (15) decibels or less. In other embodiments, amplification stage 1500 can have an ASE penalty of ten (10) decibels or less, five (5) decibels or less, or even two (2) decibels or less. In various embodiments, amplification stage 1500 can maintain a ratio of a time-averaged ASE power level co-propagating with pump signal 1510 to a minimum ASE power level co-propagating with pump signal 1510 to less than thirty (30). In other embodiments, amplification stage 1500 can maintain the ratio to less than ten (10), or even to less than three (3).

The time-averaged power level of the ASE co-propagating with a time modulated pump signal is always greater than or equal to the power level of the ASE co-propagating with the modulated pump that would be generated by a non-modulated pump signal power level and spectrum equal to the time-averaged power level and spectrum of the time modulated pump signal at each location within a gain medium. The ASE power that would be generated by this non-modulated pump signal per infinitesimal unit of length (dL) co-propagating with the modulated pump signal at a given position in the gain medium equals the time-averaged ASE power generated per length dL by and counter-propagating with the modulated pump signal at that position. In equation form, the ASE penalty can be expressed as follows:

ASE Penalty (dB)=10×log₁₀ (P_{ASE-MOD}÷P_{ASE-CW})≧0

P_{ASE-MOD} is the time-averaged power level of an ASE signal co-propagating with a time modulated pump signal. P_{ASE-CW} is the power level of an ASE signal co-propagating with the modulated pump signal but generated by a non-modulated (CW) pump signal comprising power level and spectrum equal to the time-averaged power level and spectrum of the time modulated pump signal at each location within the gain medium. In addition, measurement of the ASE signal power levels generated by the modulated and non-modulated pump signals should occur at the same location within the gain medium. The ASE penalty can be defined in terms of the measured location, such as, for example, the end of the gain medium. The ASE penalty also depends on the pump power and pump spectrum as a function of time (e.g., pump modulation properties), the ASE signal wavelength, and the properties of the gain medium.

In some cases, particularly at relatively low modulation repetition rates, the ASE penalty can be determined by measuring the power levels of the ASE signal co-propagating with the time modulated pump signal as a function of time. In those cases, the co-propagating ASE signal at a particular wavelength can comprise a higher power portion (P_{ASE-MAX}) and a lower power portion (P_{ASE-MIN}) and the time modulated pump signal can comprise a relatively fixed spectrum. In equation form, this relationship can be expressed as:

P_{ASE-MOD}÷P_{ASE-CW}=(DC_{ASE}×P_{ASE-MAX}+(1−DC_{ASE})×P_{ASE-MIN})÷P_{ASE-CW}

where DC_{ASE} is the duty cycle of the ASE signal co-propagating with the time modulated pump signal. In this example, P_{ASE-MIN} is less than or equal to P_{ASE-CW}. This relationship results because the non-modulated pump signal that generates P_{ASE-CW} comprises the same average power as the time modulated pump signal and P_{ASE-MIN} corresponds to the minimum power the time modulated pump signal which must be less than or equal to the average power of the time modulated pump signal by definition. In equation form, this relationship can be expressed as:

[(DC_{ASE}×P_{ASE-MAX})÷P_{ASE-MIN}]+(1−DC_{ASE})≧P_{ASE-MOD}÷P_{ASE-CW}

In most cases, an optical communication system is designed with a targeted overall gain and noise figure for a desired operating point. Knowing the targeted gain and noise figure, system designers can determine the maximum ASE penalty (P_{Target} (dB)) the system can tolerate without significantly degrading the noise figure above the targeted value. In various embodiments, system designers can manipulate the waveform characteristics of the time modulated pump signal to ensure that the ASE penalty does not increase the noise figure above targeted value. In equation form, this relationship can be expressed as:

[(DC_{ASE}×P_{ASE-MAX})÷P_{ASE-MIN}]+(1−DC_{ASE})≦10^{(PTarget)÷10}

This relationship may result in a slightly over designed system, but advantageously allows system designers to determine the ASE penalty of the system by monitoring only the ASE signal co-propagating with the pump signal as a function of time. This ratio need not account for intervening system losses because the losses will affect both ASE levels equally and the ratio will remain substantially unchanged. This approach is particularly valuable when it is difficult to get a reasonable estimate or measurement of P_{ASE-CW}.

This approach tends to break down, however, at low modulation frequencies when the extinction ratio of the modulated pump source is very large (e.g., P_{ASE-MIN} corresponds to the pump being turned completely off). In such cases a better estimate for P_{ASE-CW} is:

P_{ASE-CW}=2hνB₀nₛₚ×(P_{ASE-MAX}÷2hνB₀nₛₚ)\hat{ }(DC_{ASE})

where h is Plank's constant, ν is the optical frequency corresponding to the ASE power being measured, B₀ is the bandwidth over which the ASE signals are measured, and nₛₚ is a function that depends on the details of the amplifier design such as ASE signal amplification and/or attenuation as a function of position. Using this relationship, we obtain:

DC_{ASE}×(P_{ASE-MAX}÷2hνB₀nₛₚ)\hat{ }(1−DC_{ASE})≦10^{(PTarget)÷10}

where the only unmeasureable function is nₛₚ which can be estimated based on the amplifier geometry if the pump launch powers are known. In most cases, nₛₚ is greater than or equal to 1.

Another method for determining the ASE penalty involves comparing the time-averaged ASE power level (P_{ASE-MOD}) to the minimum ASE power level (P_{ASE-MIN}) of the ASE signal co-propagating with the time modulated pump signal. Setting 10×log₁₀ (P_{ASE-MOD}÷P_{ASE-MIN}) to less than or equal to a targeted value (in dB) can ensure that the maximum ASE penalty for the system is less than the targeted value. Selecting an appropriate target value thus minimizes the impact of the ASE penalty on the noise figure of the system. In equation form, this relationship can also be expressed as:

P_{ASE-MOD÷P}_{ASE-MIN}≦10^{(PTarget)÷10}

where P_{ASE-MOD} is the time-averaged ASE power level of the ASE signal co-propagating with the time modulated pump signal, and P_{ASE-MIN} is the lowest instantaneous power level of the ASE signal co-propagating with the time modulated pump signal over one complete time modulation cycle. This method advantageously allows system designers to determine the maximum ASE penalty at any point within the system. In addition, this method can be used in systems with significant dispersion because only the power level of the ASE signal co-propagating with the time modulated pump signal needs to be measured as a function of time.

Another method for determining the ASE penalty involves comparing the power levels of the ASE signal co-propagating with the time modulated pump signal and the ASE signal counter-propagating with the time modulated pump signal. In optical amplifiers where pump powers do not change appreciably over the length of the gain medium, the power level of the ASE signal counter-propagating with the time modulated pump signal is approximately equal to P_{ASE-CW}. In that case, the ASE penalty can be determined by the difference between the average power level (dBm) of the ASE signal co-propagating with the time modulated pump signal and the power level (dBm) of the ASE signal counter-propagating with the pump signal.

In practice, this method for determining the ASE penalty works reasonably well for discrete amplification stages because pump power levels do not appreciably change over the length of the gain medium. In other cases, a more detailed analysis and/or simulation is typically required to reasonably estimate the ASE penalty from the measured power levels of the ASE signals co-propagating and counter-propagating with the time modulated pump signal. In addition, system losses may affect the power levels of the measured ASE signals and should be accounted for.

FIG. 16 is a graph illustrating the impact of ASE on a noise figure of an amplification stage implementing a time modulated pump signal with a relatively low modulation repetition rate. In this example, the amplification stage operates to amplify an optical signal having a center wavelength of approximately 1590 nanometers. The horizontal axis represents the average pump power of the pump signal. The left vertical axis represents the gain of the amplification stage, while the right vertical axis represents the noise figure of the amplification stage.

In this example, the amplification stage comprises a single stage Raman amplifier having a Raman gain medium of approximately sixty-one (61) kilometers of single mode fiber. In various embodiments, the structure and function of the amplification stage can be substantially similar to amplification stage 1500 of FIG. 15. The amplification stage includes a pump source capable of pumping the Raman gain medium with a pump signal that counter-propagates the gain medium relative to an optical signal received by the gain medium. The pump signal may comprise a non-modulated pump signal, a time modulated pump signal, or a combination of pump signals.

In this example, line 1604 represents the noise figure of the amplification stage where the pump signal comprises a non-modulated pump signal having a center wavelength of approximately 1487 nanometers. Line 1606 represents the noise figure of the amplification stage where the pump signal comprises a time modulated pump signal having a center wavelength of approximately 1487 nanometers. The time modulated pump signal comprises a modulation repetition rate of approximately one (1) megahertz, a duty cycle of approximately twenty percent (20%), and an extinction ratio of approximately 10:1. In this example, line 1602 represents the gain generated within the amplification stage by both the non-modulated pump signal and the time modulated pump signal at various average pump powers.

This graph illustrates the effect of the ASE signal co-propagating with the time modulated pump signal on the noise figure of the amplification stage. This graph shows that for relatively low average pump powers and gain levels the noise figures of the time modulated system and the CW pumped system are approximately equal. In these cases, the total power associated with the ASE signal co-propagating with the time modulated pump signal is low enough that when it is reflected and/or Rayleigh scattered it has a minimal impact on the noise figure.

For both amplifier types, the noise figure of the amplification stage improves as gain increases until the power of the ASE signal co-propagating with the time modulated pump signal increases to a point that it starts to degrade the noise figure. This graph shows that at higher average pump power and gain levels, the noise figure for the time modulated pumped system begins to degrade well before the noise figure of the CW pumped system degrades. In the time modulated case, the total power associated with the ASE signal co-propagating with the time modulated pump signal is high enough that when it is reflected and/or Rayleigh scattered it has a greater impact on the noise figure. Increasing the average pump power can lead to an increase in the power of the ASE signal co-propagating with the time modulated pump signal. The increased power results because the ASE power level of the co-propagating ASE signal approximately scales with the time-averaged pump power raised to the 3.6 power. This relationship is true for pump signals with twenty percent (20%) duty cycles and extinction ratios of 10:1.

In this example, as the gain level approaches ten (10) decibels, the power of the ASE signal co-propagating with the time modulated pump signal reaches a point that it begins to degrade the noise figure of the amplification stage. To control the effect of the co-propagating ASE signal on the noise figure, system designers can manipulate the waveform characteristics of the time modulated pump signal to achieve a desired noise figure and gain. In some cases, the ASE signals co-propagating with the time modulated pump signal can be controlled by having a modulation repetition rate high enough to ensure adequate chromatic dispersion based walk off between the co-propagating ASE signals and the time modulated pump signal. In other cases, one or more waveform characteristics of the time modulated pump signal can be selected to control and/or minimize the effect of the ASE signal co-propagating with the time modulated pump signal on the noise figure of amplification stage. Therefore, for each amplification stage a minimum noise figure and an optimum gain level can be achieved by manipulating the waveform characteristics of the time modulated pump signal.

Note that the optical signal wavelength and waveform characteristics in the example described in FIG. 16 were selected arbitrarily and are only intended to depict the effect of increasing the average pump power level on the noise figure of the amplified optical signal. This disclosure is not intended to be limited to particular optical signal wavelengths or particular waveform characteristics.

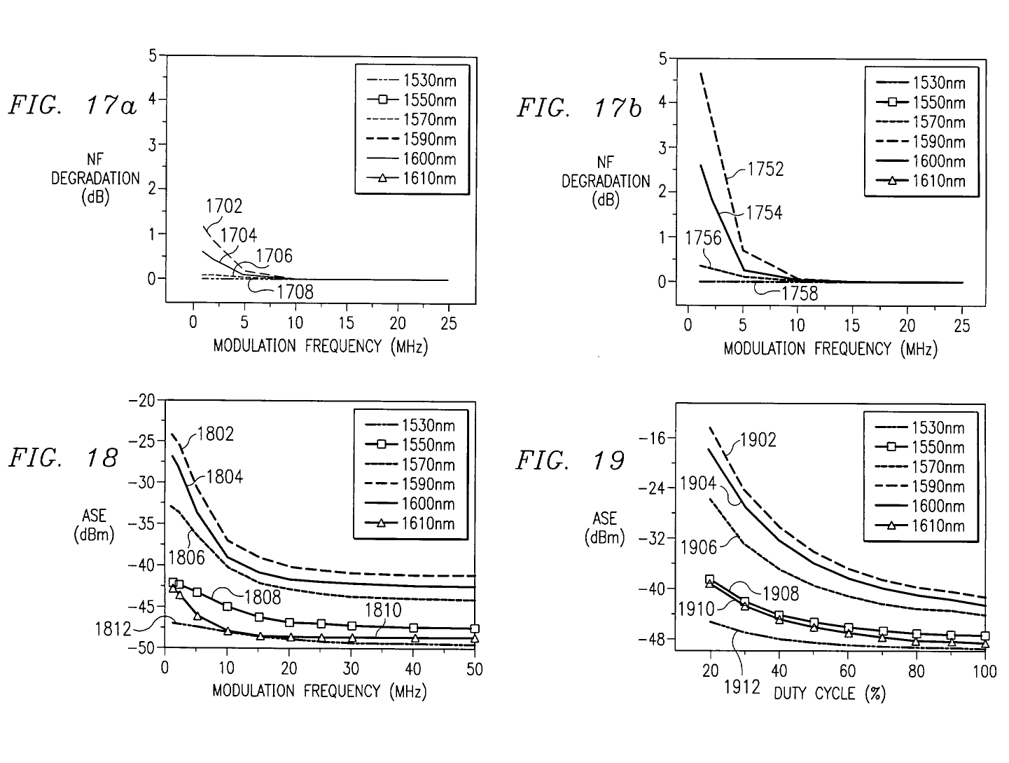

FIGS. 17A and 17B are graphs illustrating the effect of manipulating a modulation repetition rate of a time modulated pump signal on a noise figure of various optical signal wavelengths amplified within an amplification stage. In these examples, each amplification stage operates to amplify optical signals having center wavelengths ranging from 1530-1610 nanometers. Note that the optical signal wavelengths in each example illustrated in FIGS. 17-22 were selected arbitrarily and are only intended to depict the effects of manipulating a waveform characteristic on the noise figures and/or the co-propagating ASE power level of those wavelengths. This disclosure is not intended to be limited to particular optical signal wavelengths or a wavelength range.

In this example, lines 1702 and 1752 represent the noise figures of optical signal wavelengths having center wavelengths of 1590 nanometers. Lines 1704 and 1754 represent the noise figures of optical signal wavelengths having center wavelengths of 1600 nanometers. In these examples, lines 1706 and 1756 represent the noise figures of optical signal wavelengths having center wavelengths of 1570 nanometers. Lines 1708 and 1758 represent the noise figures of optical signal wavelengths having center wavelengths of 1530, 1550, and 1610 nanometers. In these examples, the horizontal axis represents the modulation repetition rate of the pump signal, while the vertical axis represents the degradation of the noise figure resulting from the reflected and/or Rayleigh scattered ASE.

In each of these examples, each amplification stage comprises a single stage Raman amplification stage having a Raman gain medium of approximately sixty-one (61) kilometers of single mode fiber. The amplification stages also include a pump source capable of pumping the Raman gain medium with a time modulated pump signal having a center wavelength of approximately 1487 nanometers. In these examples, each time modulated pump signal comprises a duty cycle of approximately twenty percent (20%), and an average pump power of approximately 600 milliwatts. The time modulated pump signal of FIG. 17A comprises a modulation depth of approximately ten (10) decibels, while the time modulated pump signal of FIG. 17B comprises a modulation depth of approximately thirteen (13) decibels.

These figures illustrate the effect of manipulating the modulation repetition rate of the time modulated pump signals on the noise figure of the amplification stages. As shown by these figures, increasing the modulation repetition rate of a time modulated pump signal can reduce the effect of reflected and/or Rayleigh scattered ASE on the noise figure of the amplification stage for any time modulated pump signal. For example, line 1702 shows that noise figure degradation is reduced from approximately 1.2 decibels to approximately zero decibels as the modulation repetition rate of the time modulated pump signal increases from approximately one (1) megahertz to approximately ten (10) megahertz. Similarly, line 1752 shows that noise figure degradation is reduced from approximately 4.6 decibels to approximately zero decibels by increasing the modulation repetition rate of the time modulated pump signal.

FIG. 18 is a graph illustrating the effect of manipulating a modulation repetition rate of a time modulated pump signal on the relative power of ASE signals that co-propagate with the time modulated pump signal. In this example, an amplification stage operates to amplify optical signals having center wavelengths ranging from 1530-1610 nanometers.

In this example, line 1802 represents the ASE signal power co-propagating with the time modulated pump signal at an optical signal wavelength of 1590 nanometers. Similarly, lines 1804, 1806, 1808, 1810, and 1812 represent the ASE signal power co-propagating with the time modulated pump signal at optical signal wavelengths of 1600, 1570, 1550, 1610, and 1530 nanometers, respectively. In this example, the horizontal axis represents the modulation repetition rate of the pump signal, while the vertical axis represents the relative power of the ASE signals generated while co-propagating with the time modulated pump signal.

In this example, the amplification stage comprises a single stage Raman amplification stage having a Raman gain medium of approximately sixty-one (61) kilometers of single mode fiber. The amplification stage also includes a pump source capable of pumping the Raman gain medium with a time modulated pump signal having a center wavelength of approximately 1487 nanometers. In this example, the time modulated pump signal comprises a modulation depth of approximately ten (10) decibels, a duty cycle of approximately thirty percent (30%), and an average pump power of approximately 600 milliwatts.

This graph illustrates that increasing the modulation repetition rate of a time modulated pump signal can reduce the relative power of the ASE signals co-propagating with the time modulated pump signal. For example, line 1802 shows that the relative power of the 1590 nanometer ASE signal decreases by approximately sixteen (16) decibels as the modulation repetition rate increases from approximately one (1) megahertz to approximately twenty (20) megahertz. This reduction in relative power of the ASE signal results from an increase in the walk off effect between the ASE signals and the time modulated pump signal. The increased walk off effect, relative to the modulation cycle time, can further be enhanced by selecting a gain medium having sufficient dispersivity to encourage rapid walk-off.

FIG. 19 is a graph illustrating the effect of manipulating a duty cycle of a time modulated pump signal on the magnitude of ASE that co-propagates with the time modulated pump signal. In this example, an amplification stage operates to amplify optical signals having center wavelengths ranging from 1530-1610 nanometers.

In this example, line 1902 represents the ASE signal power co-propagating with the time modulated pump signal at an optical signal wavelength of 1590 nanometers. Similarly, lines 1904, 1906, 1908, 1910, and 1912 represent the ASE signal power co-propagating with the time modulated pump signal at optical signal wavelengths of 1600, 1570, 1550, 1610, and 1530 nanometers, respectively. In this example, the horizontal axis represents the duty cycle of the pump signal, while the vertical axis represents the relative power of the ASE signals generated while co-propagating with the time modulated pump signal.

In this example, the amplification stage comprises a single stage Raman amplification stage having a Raman gain medium of approximately sixty-one (61) kilometers of single mode fiber. The amplification stage also includes a pump source capable of pumping the Raman gain medium with a time modulated pump signal having a center wavelength of approximately 1487 nanometers. In this example, the time modulated pump signal comprises a modulation repetition rate of approximately one (1) megahertz, a modulation depth of approximately ten (10) decibels, and an average pump power of approximately 600 milliwatts.

This graph illustrates that increasing the duty cycle of a time modulated pump signal can reduce the relative power of the ASE signals co-propagating with the time modulated pump signal. For example, line 1902 shows that the relative power of the 1590 nanometer ASE signal decreases by approximately nineteen (19) decibels as the duty cycle increases from approximately twenty percent (20%) to approximately fifty percent (50%). This reduction in relative power of the ASE signal results from increasing the duty cycle while maintaining the average power of the pump source.

Increasing the duty cycle while maintaining an average pump power tends to yield a time modulated pump signal where the higher power portion of the signal comprises a larger portion of the modulation period, but has a reduced peak power. Reducing the peak power of the time modulated pump signal reduces the magnitude of the peak and/or time-averaged gain experienced by the ASE signals co-propagating with the pump signal. In addition, the lower power portion of the time modulated pump signal comprises a smaller portion of the modulation period.

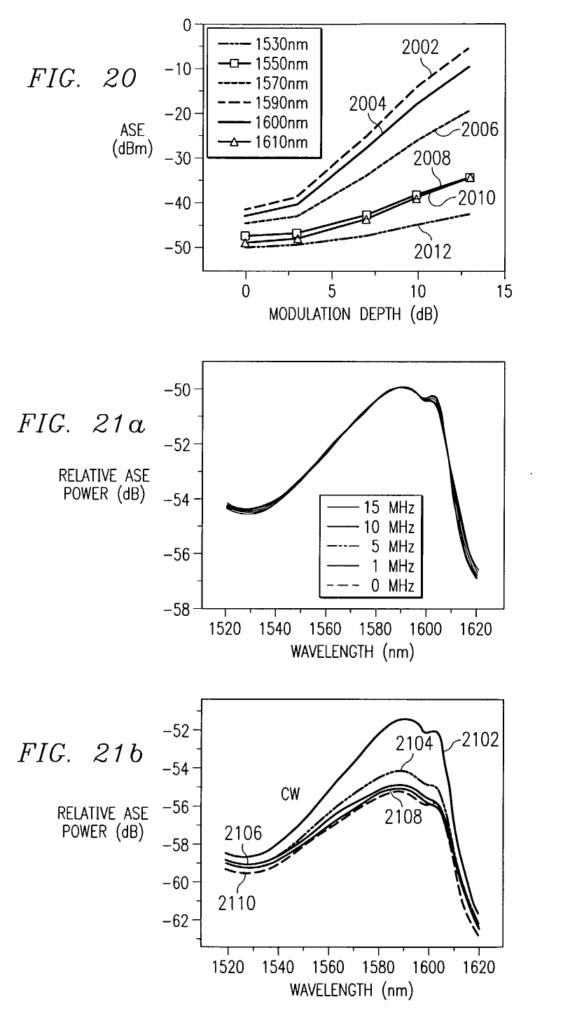

FIG. 20 is a graph illustrating the effect of manipulating a modulation depth (e.g., extinction ratio) of a time modulated pump signal on the magnitude of ASE that co-propagates with the time modulated pump signal. In this example, an amplification stage operates to amplify optical signals having center wavelengths ranging from 1530-1610 nanometers.

In this example, line 2002 represents the ASE signal power co-propagating with the time modulated pump signal at an optical signal wavelength of 1590 nanometers. Similarly, lines 2004, 2006, 2008, 2010, and 2012 represent the ASE signal power co-propagating with the time modulated pump signal at optical signal wavelengths of 1600, 1570, 1550, 1610, and 1530 nanometers, respectively. In this example, the horizontal axis represents the modulation depth of the pump signal, while the vertical axis represents the relative power of the ASE signals generated while co-propagating with the time modulated pump signal.

In this example, the amplification stage comprises a single stage Raman amplification stage having a Raman gain medium of approximately sixty-one (61) kilometers of single mode fiber. The amplification stage also includes a pump source capable of pumping the Raman gain medium with a time modulated pump signal having a center wavelength of approximately 1487 nanometers. In this example, the time modulated pump signal comprises a modulation repetition rate of approximately one (1) megahertz, a duty cycle of approximately twenty percent (20%), and an average pump power of approximately 600 milliwatts.

This graph illustrates that reducing the modulation depth (e.g., extinction ratio) of a time modulated pump signal can reduce the power of the ASE signals co-propagating with the time modulated pump signal. For example, line 2002 shows that the power of the 1590 nanometer ASE signal decreases by approximately thirty-five (35) decibels as the modulation depth decreases from approximately thirteen (13) decibels to approximately three (3) decibels. This reduction in relative power of the ASE signal results from reducing the difference between the peak power and the minimum power of the time modulated pump signal.

FIGS. 21A and 21B are graphs illustrating experimental results showing the effect of manipulating the modulation repetition rate on the relative power of the ASE signal generated by a time modulated pump signal. In this example, the horizontal axis represents the optical signal wavelengths amplified by the amplification stages, while the vertical axis represents the relative power of the ASE signal generated by the time modulated pump signal.

In this example, the structure and function of the amplification stage can be substantially similar to amplification stage 1500 of FIG. 15. The amplification stage comprises a single stage Raman amplification stage having a Raman gain medium of approximately sixty-one (61) kilometers of single mode fiber. The amplification stage also includes a pump source capable of pumping the Raman gain medium with a time modulated pump signal having a center wavelength of approximately 1487 nanometers. In this example, the time modulated pump signal comprises an extinction ratio of 5:1, a duty cycle of approximately thirty percent (30%), and an average pump power of approximately 230 milliwatts.

FIG. 21A illustrates the relative power of the ASE signal counter-propagating with the time modulated pump signal. In this example, the modulation repetition rate of the time modulated pump signal is varied from zero megahertz (e.g., a non-modulated pump signal) to approximately 15 megahertz. This figure shows that the relative power of the ASE signal counter-propagating with respect to the time modulated pump signal remains approximately constant upon the manipulation of the modulation repetition rate. In other words, the relative power of the ASE signal counter-propagating with respect to the pump signal is insensitive to changes in the modulation repetition rate of the pump signal.

FIG. 21B illustrates the relative power of the ASE signal co-propagating with the time modulated pump signal. In this example, line 2102 represents the spectral response of an optical signal wavelength range amplified by a time modulated pump signal having a modulation repetition rate of approximately one (1) megahertz. Similarly, lines 2104, 2106, and 2108 represent the spectral response of an optical signal wavelength range amplified by time modulated pump signals having modulation repetition rates of five (5), ten (10), and fifteen (15) megahertz, respectively. Line 2110 represents the magnitude of ASE power generated by a non-modulated or continuous wave pump signal.

As shown in FIG. 21B, the relative power of the ASE signal co-propagating with the time modulated pump signal decreases as the modulation repetition rate increases. In other words, as the modulation repetition rate increases chromatic dispersion can cause the ASE to walk through an increasing number of complete pump time modulation cycles making the pump look increasingly like a CW source having the same average power. The rate at which the relative ASE signal power decreases diminishes as the modulation repetition rate increases.

Note that the optical signal wavelengths and waveform characteristics were selected arbitrarily in this experiment and are only intended to confirm the effects of manipulating the modulation repetition rate on the relative power of the ASE signal. This disclosure is not intended to be limited to particular optical signal wavelengths, waveform characteristics, and/or results depicted with respect to this experiment. By varying the waveform characteristics, pump powers, fiber types, etc., the relative power of the ASE signal generated by a time modulated pump signal can be controlled and/or minimized.

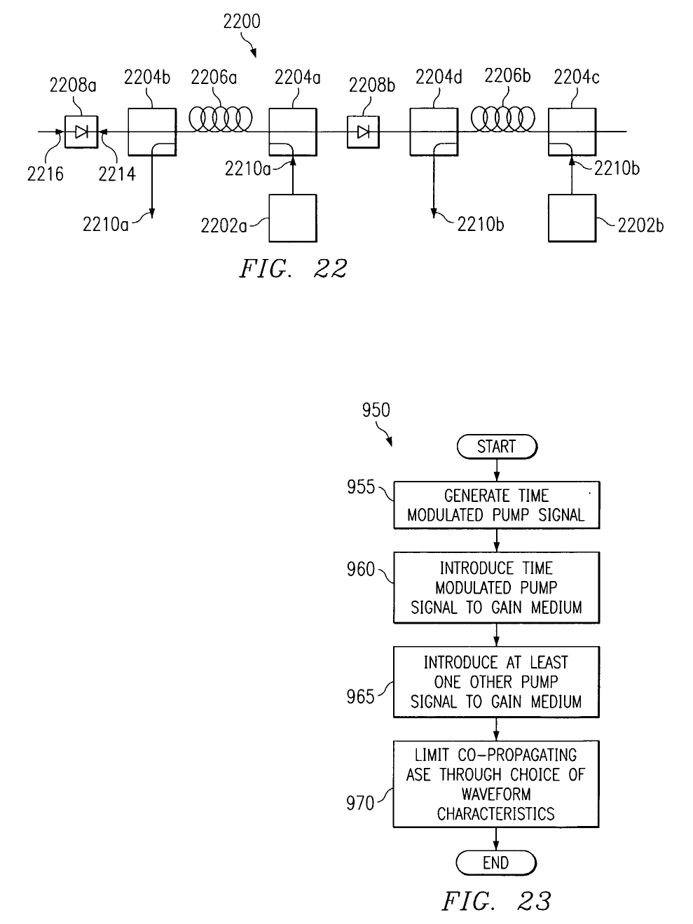

FIG. 22 is a block diagram illustrating a multiple stage discrete Raman amplifier 2200 capable of minimizing the effect of ASE on a noise figure associated with amplifier 2200. In this example, amplifier 2200 includes at least a first pump source 2202a and a second pump source 2202b. Although this example utilizes two pump sources 2202a and 2202b, any number of pump sources can be used without departing from the scope of the present disclosure. In this example, first pump source 2202a is capable of generating at least one pump signal 2210a comprising at least one time modulated pump signal. Similarly, second pump source 2202b is capable of generating at least one pump signal 2210b comprising at least one time modulated pump signal. Pump sources 2202a and 2202b may comprise any device capable of generating the desired pump signals 2210a and 2210b, such as, for example, at least one optical source. In various embodiments, pump sources 2202 can be substantially similar to pump assembly 114 of FIG. 2.

In this embodiment, pump signals 2210a and 2210b comprise at least one time modulated pump signal. In other embodiments, pump signals 2210a and 2210b can comprise at least one non-modulated pump signal or a combination of time modulated pump signals and non-modulated pump signals. Pump signal 2210a amplifies an optical signal 2216 in a first gain medium 2206a. Similarly, pump signal 2210b amplifies optical signal 2216 in a second gain medium 2206b. In various embodiments, each gain medium 2206a and 2206b may comprise a gain fiber. In other embodiments, at least a portion of each gain medium 2206a and 2206b may comprise a dispersion compensating fiber.

In this example, amplifier 2200 includes a first pump input coupler 2204a, a second pump input coupler 2204c, a first pump output coupler 2204b, and a second pump output coupler 2204d. Couplers 2204a-2204d can comprise any device capable of coupling and/or decoupling pump signals 2210a and 2210b to and/or from amplifier 2200. In this particular embodiment, couplers 2204a-2204d comprise wavelength division multiplexers. Pump input coupler 2204a operates to introduce pump signal 2210a to first gain medium 2206a and pump output coupler 2204b operates to de-couple pump signal 2210a from gain medium 2206a after amplifying optical signal 2216. Similarly, pump input coupler 2204c and pump output coupler 2204d operate to introduce and remove pump signal 2210b from gain medium 2206b.

In this example, amplifier 2200 includes at least a first optical isolator 2208a and a second optical isolator 2208b. Although this example includes two optical isolators 2208a and 2208b, any number of optical isolators can be used without departing from the scope of the present disclosure. First optical isolator 2208a operates to reduce the amount of ASE generated by and co-propagating with pump signal 2210a that is reflected and/or Rayleigh scattered into gain medium 2206a by elements located past isolator 2208a. Similarly, second optical isolator 2208b operates to reduce the amount of ASE generated by and co-propagating with pump signal 2210b that is reflected and/or Rayleigh scattered into gain medium 2206b by elements located past isolator 2208b, such as, gain medium 2206a. Optical isolators 2208a and 2208b may comprise any device capable of reducing the amount of ASE co-propagating with optical signal 2216.

In various embodiments, implementing a multiple stage amplifier with optical isolators can provide relatively lower ASE power levels than a single stage amplifier capable of generating a substantially similar overall gain. A multiple-stage amplifier reduces the ASE power levels because the ASE signals experience smaller magnitudes of gain and the optical isolators reduce the amount of ASE reflected and/or Rayleigh scattered into other amplification stages.

FIG. 23 is a flow chart illustrating one example of a method 950 of amplifying optical signals using at least one time modulated pump signal. For ease of description, method 950 will be described with reference to optical amplification stage 1500 shown in FIG. 15. Method 950 could, however, apply to any of a variety of optical amplification systems implementing at least one stage of Raman amplification.

In this example, method 950 begins at step 955 where pump source 1502 generates a plurality of pump signals 1510 comprising at least one time modulated pump signal. In this example, the time modulated pump signal comprises an optical signal that periodically varies between a higher power portion and a lower power portion. In some embodiments, the lower power portion can comprise a non-zero power portion. In other embodiments, the lower power portion could comprise a zero power portion.

Amplification stage 1500 introduces the time modulated pump signal to gain medium 1506 at step 960. In a similar manner, amplification stage 1500 also introduces at least one other pump signal to gain medium 1506 at step 965. In this particular example, coupler 1504a of amplification stage 1500 couples plurality of pump signals 1510 to gain medium 1506. In other embodiments, each of the plurality of pump signal 1510 could be separately introduced to gain medium 1506 using separate couplers. Moreover, if pump signal 1510 comprises more than one time modulated signal, the time modulated pump signals can implement modulation schemes where the initial leading edges of various time modulated pump signals occur approximately simultaneously. Alternatively, modulation of various time modulated pump signals can begin with the leading edges of those pump signals at different times with respect to each other at a reference point, such as, the pump input end of gain medium 1506.

Amplification stage 1500 controls and/or minimizes the effect of reflected and/or Rayleigh scattered ASE power on the noise figure of amplification stage 1500 through appropriate choice of waveform characteristics associated with time modulated pump signals at step 970. In one embodiment, a modulation repetition rate of the time modulated pump signal can be increased to a sufficiently high level. In other embodiments, selecting a duty cycle, an extinction ratio, and/or a peak power of the modulation waveform can control and/or minimize the impact of the ASE on amplification stage 1500. Using any one or a combination of these characteristics (and possibly other characteristics as well) can enable various degrees of design freedom in controlling and/or minimizing the ASE power levels co-propagating and counter-propagating with respect to the time modulated pump signal. Alternatively, or in addition, a maximum gain level for the amplifier can be chosen to reduce the ASE power levels in time modulated pumping schemes.

Although the present invention has been described in several embodiments, a myriad of changes, variations, alterations, transformations, and modifications may be suggested to one skilled in the art, and it is intended that the present invention encompass such changes, variations, alterations, transformations, and modifications as falling within the spirit and scope of the appended claims.

What is claimed is:

1. An optical amplifier comprising at least one Raman amplification stage, the Raman amplification stage comprising:
one or more pump sources operable to generate a plurality of pump signals capable of being delivered to a gain medium carrying an optical signal;
wherein at least one of the plurality of pump signals comprises a time modulated pump signal and wherein an amplified spontaneous emission penalty associated with the at least one time modulated pump signal comprises no more than fifteen (15) decibels.

2. The optical amplifier of claim 1, wherein each of the plurality of pump signals comprises a different center wavelength.

3. The optical amplifier of claim 1, wherein at least two of the plurality of pump signals comprise orthogonally polarized pump signals comprising approximately the same center wavelength.

4. The optical amplifier of claim 1, wherein the time modulated pump signal propagates through the gain medium counter to the direction of the optical signal.

5. The optical amplifier of claim 4, further comprising a pump signal traversing through the gain medium in the same direction as the optical signal.

6. The optical amplifier of claim 1, wherein each of the plurality of pump signals propagate through the gain medium counter to the direction of the optical signal.

7. The optical amplifier of claim 1, wherein the optical signal comprises a multiple wavelength optical signal.

8. The optical amplifier of claim 1, wherein a modulation waveform of the time modulated pump signal is selected to control power transfer between others of the plurality of pump signals and the time modulated pump signal.

9. The optical amplifier of claim 1, wherein the time modulated pump signal comprises a substantially periodic variation between a higher power portion and a lower power portion.

10. The optical amplifier of claim 9, wherein the higher power portion of the time modulated pump signal comprises no more than thirty percent (30%) of a representative period of the time modulated pump signal.

11. The optical amplifier of claim 9, wherein the higher power portion of the time modulated pump signal comprises at least thirty percent (30%) of a representative period of the time modulated pump signal.

12. The optical amplifier of claim 1, wherein the time modulated pump signal comprises a non-zero minimum power level.

13. The optical amplifier of claim 1, wherein all wavelengths of the optical signal experience an amplified spontaneous emission penalty of no more than fifteen (15) decibels.

14. The optical amplifier of claim 1, wherein at least one waveform characteristic of the time modulated pump signal is selected to control an amplified spontaneous emission penalty co-propagating with the at least one time modulated pump signal while maintaining a desired gain level.

15. The optical amplifier of claim 14, wherein the at least one waveform characteristic of the time modulated pump signal comprises a characteristic selected from a group consisting of a modulation repetition rate, a duty cycle, an extinction ratio, and a peak power.

16. The optical amplifier of claim 14, wherein the at least one waveform characteristic of the time modulated pump signal comprises a duty cycle of at least twenty (20) percent.

17. The optical amplifier of claim 14, wherein the at least one waveform characteristic of the time modulated pump signal comprises a modulation depth of no more than thirteen (13) decibels.

18. The optical amplifier of claim 14, wherein the at least one waveform characteristic of the time modulated pump signal comprises a modulation repetition rate of at least 500 kilohertz.

19. The optical amplifier of claim 14, wherein the at least one waveform characteristic of the time modulated pump signal comprises a modulation repetition rate of at least two (2) megahertz.

20. The optical amplifier of 14, wherein the at least one waveform characteristic of the time modulated pump signal comprises a modulation repetition rate of at least ten (10) megahertz.

21. The optical amplifier of claim 1, wherein at least a non-zero power portion of the time modulated pump signal at least partially overlaps with a non-zero power portion of another of the plurality of pump signals over at least a portion of the gain medium.

22. The optical amplifier of claim 1, wherein the peak power of the time modulated pump signal increases as a result of interaction with another of the plurality of pump signals over at least a portion of the gain medium.

23. The optical amplifier of claim 1, wherein a maximum peak power of the time modulated pump signal occurs at some distance from a location where the time modulated pump signal enters the gain medium.

24. The optical amplifier of claim 1, wherein the time modulated pump signal comprises a peak power that is higher than a maximum rated continuous wave (CW) power of an optical source generating the time modulated pump signal.

25. The optical amplifier of claim 1, wherein each of the plurality of pump signals is generated by a separate optical source.

26. The optical amplifier of claim 1, wherein the time modulated pump signal is generated by a semiconductor laser diode receiving a modulated drive current.

27. The optical amplifier of claim 1, wherein the gain medium comprises at least a portion of a transmission fiber in a distributed Raman amplification stage.

28. The optical amplifier of claim 1, wherein the gain medium comprises a gain fiber in a discrete Raman amplification stage.

29. The optical amplifier of claim 1, wherein the amplified spontaneous emission penalty associated with the at least one time modulated pump signal comprises no more than ten (10) decibels.

30. The optical amplifier of claim 1, wherein the amplified spontaneous emission penalty associated with the at least one time modulated pump signal comprises no more than five (5) decibels.

31. The optical amplifier of claim 1, wherein the amplified spontaneous emission penalty associated with the at least one time modulated pump signal comprises no more than two (2) decibels.

32. The optical amplifier of claim 1, wherein the amplified spontaneous emission penalty is based at least in part on an amplified spontaneous emission signal co-propagating with the at least one time modulated pump signal.

33. The optical amplifier of claim 1, wherein at least two of the plurality of pump signals comprise time modulated pump signals.

34. The optical amplifier of claim 33, further comprising a control module operable to synchronize at least some of the at least two time modulated pump signals over at least a portion of the gain medium.

35. The optical amplifier of claim 34, wherein the control module comprises one or more phase shifters operable to alter the phases of at least one of the at least two time modulated pump signals relative to at least one other of the at least two time modulated pump signals.

36. The optical amplifier of claim 34, wherein the control module comprises:
one or more modulators operable to generate electronic waveforms to be applied as drive currents to the pump assembly to generate the at least two time modulated pump signals; and
one or more electronic phase shifters operable to alter the phases of the electronic waveforms relative to one another.

37. The optical amplifier of claim 1, wherein the at least one Raman amplifier stage comprises a lower average noise figure over at least a portion of the gain spectrum than the same amplifier stage would exhibit if the time modulated pump signal were held at a constant power.

38. The optical amplifier of claim 1, wherein at least one waveform characteristic of the at least one time modulated pump signal is selected to maintain a ratio of a time-averaged amplified spontaneous emission (ASE) power level to a minimum ASE power level of less than thirty (30), and wherein the time-averaged ASE power level and the minimum ASE power level co-propagate with the at least one time modulated pump signal.

39. The optical amplifier of claim 1, further comprising:
another one or more pump sources operable to generate another plurality of pump signals capable of being delivered to another gain medium carrying at least some of wavelengths of the optical signal;
at least one optical isolator coupled between the gain medium and the another gain medium and operable to remove at least a portion of an amplified spontaneous emission signal that is propagating in the same direction as at least some of the another plurality of pump signals.

40. An optical amplifier comprising at least one Raman amplification stage, the Raman amplification stage comprising:
one or more pump sources operable to generate a plurality of pump signals capable of being delivered to a gain medium carrying an optical signal, wherein at least one of the plurality of pump signals comprises a time modulated pump signal;
wherein at least one waveform characteristic of the time modulated pump signal is selected to maintain a ratio of a time-averaged amplified spontaneous emission (ASE) power level to a minimum ASE power level of less than thirty (30); and
wherein the time-averaged ASE power level and the minimum ASE power level co-propagate with the at least one time modulated pump signal.

41. The optical amplifier of claim 40, wherein the gain medium comprises a portion of a distributed Raman amplification stage.

42. The optical amplifier of claim 40, wherein the time modulated pump signal propagates through the gain medium counter to the direction of the optical signal.

43. The optical amplifier of claim 40, wherein the time modulated pump signal comprises a non-zero minimum power level.

44. The optical amplifier of claim 40, wherein at least one other of the plurality of pump signals comprises a non-modulated non-zero power pump signal.

45. The optical amplifier of claim 40, wherein at least two of the plurality of pump signals comprise time modulated pump signals.

46. The optical amplifier of claim 40, wherein the at least one waveform characteristic of the time modulated pump signal comprises a characteristic selected from a group consisting of a modulation repetition rate, a duty cycle, an extinction ratio, and a peak power.

47. The optical amplifier of claim 40, wherein the at least one waveform characteristic of the time modulated pump signal comprises a duty cycle of at least twenty (20) percent.

48. The optical amplifier of claim 40, wherein the at least one waveform characteristic of the time modulated pump signal comprises a modulation depth of no more than thirteen (13) decibels.

49. The optical amplifier of claim 40, wherein the at least one waveform characteristic of the time modulated pump signal comprises a modulation repetition rate of at least 500 kilohertz.

50. The optical amplifier of claim 40, wherein the at least one waveform characteristic of the time modulated pump signal comprises a modulation repetition rate of at least ten (10) megahertz.

51. The optical amplifier of claim 40, wherein the at least one waveform characteristic of the time modulated pump signal is selected to maintain the ratio of the time-averaged ASE power level to the minimum ASE power level of less than ten (10).

52. The optical amplifier of claim 40, wherein the at least one waveform characteristic of the time modulated pump signal is selected to maintain the ratio of the time-averaged ASE power level to the minimum ASE power level of less than three (3).

53. The optical amplifier of claim 40, wherein the at least one waveform characteristic of the time modulated pump signal is selected to provide a gain enhancement to the Raman amplifier stage compared to a signal gain that stage would experience if the time modulated pump signal was a continuous wave signal.

54. The optical amplifier of claim 53, wherein the gain enhancement comprises a higher gain level than the amplifier stage would experience if the time modulated pump signal was a continuous wave signal having the same average power.

55. The optical amplifier of claim 53, wherein the gain enhancement comprises a flatter gain profile over at least a portion of the wavelengths received by the amplifier stage than the amplifier stage would experience if the time modulated pump signal was a continuous wave signal having the same average power.

56. The optical amplifier of claim 53, wherein the gain enhancement comprises a reduced average pump power in at least one pump signal needed to achieve the same signal gain that the amplifier stage would experience if the time modulated pump signal was a continuous wave signal.

57. The optical amplifier of claim 40, wherein the at least one waveform characteristic of the time modulated pump signal comprises a modulation repetition rate of no more than 10 megahertz and wherein another waveform characteristic of the time modulated pump signal is selected to reduce a noise figure of the amplifier stage.

58. The optical amplifier of claim 57, wherein the another waveform characteristic of the time modulated pump signal comprises a characteristic selected from a group consisting of a duty cycle, an extinction ratio, and a peak power.

59. The optical amplifier of claim 40, wherein the optical signal comprises a multiple wavelength optical signal.

60. The optical amplifier of claim 40, wherein the at least one waveform characteristic of the time modulated pump signal is selected to maintain the ratio of the time-averaged ASE power level to the minimum ASE power level of less than thirty (30) for all wavelengths of the optical signal.

61. An optical amplifier comprising at least one Raman amplification stage, the Raman amplification stage comprising:
one or more pump sources operable to generate a plurality of pump signals capable of being delivered to a gain medium carrying an optical signal, wherein at least one of the plurality of pump signals comprises a time modulated pump signal;
wherein a modulation rate of the time modulated pump signal is no more than 10 megahertz and wherein another waveform characteristic of the time modulated pump signal is selected to reduce a noise figure of the amplifier stage.

62. The optical amplifier of claim 61, wherein the modulation rate of the time modulated pump signal is no more than 5 megahertz.

63. The optical amplifier of claim 61, wherein a modulation rate of the time modulated pump signal is no more than 3 megahertz.

64. The optical amplifier of claim 61, wherein a modulation rate of the time modulated pump signal is no more than 1 megahertz.

65. The optical amplifier of claim 61, wherein the another waveform characteristic of the time modulated pump signal comprises a characteristic selected from a group consisting of a duty cycle, an extinction ratio, and a peak power.

66. The optical amplifier of claim 61, wherein the another waveform characteristic of the time modulated pump signal comprises a duty cycle of at least twenty (20) percent.

67. The optical amplifier of claim 61, wherein the another waveform characteristic of the time modulated pump signal comprises a modulation depth of no more than thirteen (13) decibels.

68. The optical amplifier of claim 61, wherein a maximum gain level of the amplification stage is selected to obtain a minimum noise figure.

69. The optical amplifier of claim 61, wherein an amplified spontaneous emission penalty associated with the at least one time modulated pump signal comprises no more than fifteen (15) decibels.

70. The optical amplifier of claim 61, wherein the another waveform characteristic of the time modulated pump signal is selected to maintain a ratio of a time-averaged amplified spontaneous emission (ASE) power level to a minimum ASE power level of less than thirty (30), and wherein the time-averaged ASE power level and the minimum ASE power level co-propagate with the at least one time modulated pump signal.

71. An optical amplifier comprising at least one Raman amplification stage, the Raman amplification stage comprising:
one or more pump sources operable to generate a plurality of pump signals capable of being delivered to a gain medium carrying an optical signal, wherein at least one of the plurality of pump signals comprises a time modulated pump signal;
wherein a modulation repetition rate of the time modulated pump signal is selected to provide a noise figure degradation of one (1) decibel or less for at least some wavelengths of the optical signal.

72. The optical amplifier of claim 71, wherein the modulation repetition rate comprises at least 500 kilohertz.

73. The optical amplifier of claim 71, wherein the modulation repetition rate comprises at least one (1) megahertz.

74. The optical amplifier of claim 71, wherein the modulation repetition rate comprises at least ten (10) megahertz.

75. The optical amplifier of claim 71, wherein the modulation repetition rate comprises no more than five (5) megahertz.

76. The optical amplifier of claim 71, wherein an amplified spontaneous emission penalty associated with the at least one time modulated pump signal comprises no more than fifteen (15) decibels.

77. The optical amplifier of claim 71, wherein another waveform characteristic of the time modulated pump signal is selected to maintain a ratio of a time-averaged amplified spontaneous emission (ASE) power level to a minimum ASE power level of less than thirty (30), and wherein the time-averaged ASE power level and the minimum ASE power level co-propagate with the at least one time modulated pump signal.

78. A method of amplifying optical signals in a Raman amplification stage, comprising:
generating a plurality of pump signals, wherein at least one of the plurality of pump signals comprises a time modulated pump signal;
introducing the plurality of pump signals to a gain medium carrying an optical signal;
wherein an amplified spontaneous emission penalty associated with the at least one time modulated pump signal comprises no more than fifteen (15) decibels.

79. The method of claim 78, wherein the time modulated pump signal propagates through the gain medium counter to the direction of the optical signal.

80. The method of claim 78, wherein the amplified spontaneous emission penalty associated with the at least one time modulated pump signal comprises no more than ten (10) decibels.

81. The method of claim 78, wherein the amplified spontaneous emission penalty associated with the at least one time modulated pump signal comprises no more than two (2) decibels.

82. The method of claim 78, further comprising selecting at least one waveform characteristic of the time modulated pump signal to control the amplified spontaneous emission penalty associated with the at least one time modulated pump signal while maintaining a gain level of the Raman amplification stage.

83. The method of claim 82, wherein the at least one waveform characteristic of the time modulated pump signal comprises a characteristic selected from a group consisting of a modulation repetition rate, a duty cycle, an extinction ratio, and a peak power.

84. The method of claim 82, wherein the at least one waveform characteristic of the time modulated pump signal comprises a duty cycle of at least twenty (20) percent.

85. The method of claim 82, wherein the at least one waveform characteristic of the time modulated pump signal comprises a modulation depth of no more than thirteen (13) decibels.

86. The method of claim 82, wherein the at least one waveform characteristic of the time modulated pump signal comprises a modulation repetition rate of at least 500 kilohertz.

87. The method of claim 82, wherein the at least one waveform characteristic of the time modulated pump signal comprises a modulation repetition rate of at least ten (10) megahertz.

88. The method of claim 82, wherein the at least one waveform characteristic of the time modulated pump signal comprises a modulation repetition rate of no more than ten (10) megahertz.

89. The method of claim 88, further comprising selecting another waveform characteristic of the time modulated pump signal to reduce a noise figure of the amplifier stage.

90. The method of claim 89, wherein the another waveform characteristic of the time modulated pump signal comprises a characteristic selected from a group consisting of a duty cycle, an extinction ratio, and a peak power.

91. The method of claim 78, wherein the time modulated pump signal comprises a peak power that is higher than an average power output by an optical source generating that pump signal.

92. The method of claim 78, further comprising selecting at least one waveform characteristic of the time modulated pump signal to maintain a ratio of a time-averaged amplified spontaneous emission (ASE) power level to a minimum ASE power level of less than thirty (30), and wherein the time-averaged ASE power level and the minimum ASE power level co-propagate with the at least one time modulated pump signal.

93. A method of amplifying optical signals in a Raman amplification stage, comprising:
generating a plurality of pump signals capable of being delivered to a gain medium carrying an optical signal, wherein at least one of the plurality of pump signals comprises a time modulated pump signal; and
selecting at least one waveform characteristic of the time modulated pump signal to maintain a ratio of a time-averaged amplified spontaneous emission (ASE) power level to a minimum ASE power level of less than thirty (30); and
wherein the time-averaged ASE power level and the minimum ASE power level co-propagate with the at least one time modulated pump signal.

94. The method of claim 93, wherein the gain medium comprises a portion of a distributed Raman amplification stage.

95. The method of claim 93, wherein the at least one waveform characteristic of the time modulated pump signal comprises a characteristic selected from a group consisting of a modulation repetition rate, a duty cycle, an extinction ratio, and a peak power.

96. The method of claim 93, wherein the at least one waveform characteristic of the time modulated pump signal a duty cycle of at least twenty (20) percent.

97. The method of claim 93, wherein the at least one waveform characteristic of the time modulated pump signal comprises a modulation depth of no more than thirteen (13) decibels.

98. The method of claim 93, wherein the at least one waveform characteristic of the time modulated pump signal comprises a modulation repetition rate of at least 500 kilohertz.

99. The method of claim 93, wherein the at least one waveform characteristic of the time modulated pump signal comprises a modulation repetition rate of at least ten (10) megahertz.

100. The method of claim 93, wherein the at least one waveform characteristic of the time modulated pump signal is selected to provide a gain enhancement to the Raman amplifier stage compared to the signal gain that stage would experience if the time modulated pump signal was a continuous wave signal.

101. The method of claim 100, wherein the gain enhancement comprises a higher gain level than the amplifier stage would experience if the time modulated pump signal was a continuous wave signal having the same average power.

102. The method of claim 100, wherein the gain enhancement comprises a reduced average pump power in at least one pump signal needed to achieve the same signal gain that the amplifier stage would experience if the time modulated pump signal was a continuous wave signal.

103. The method of claim 93, wherein the at least one waveform characteristic of the time modulated pump signal is selected to maintain the ratio of the time-averaged ASE power level to the minimum ASE power level of less than ten (10).

104. The method of claim 93, wherein the at least one waveform characteristic of the time modulated pump signal is selected to maintain the ratio of the time-averaged ASE power level to the minimum ASE power level of less than three (3).

105. The method of claim 93, wherein the at least one waveform characteristic of the time modulated pump signal comprises a modulation repetition rate of no more than 10 megahertz.

106. The method of claim 105, further comprising selecting another waveform characteristic of the time modulated pump signal to reduce a noise figure of the amplifier stage.

107. The method of claim 106, wherein the another waveform characteristic of the time modulated pump signal comprises a characteristic selected from a group consisting of a duty cycle, an extinction ratio, and a peak power.

108. A method of amplifying optical signals in a Raman amplification stage, comprising:
generating a plurality of pump signals capable of being delivered to a gain medium carrying an optical signal, wherein at least one of the plurality of pump signals comprises a time modulated pump signal, and wherein a modulation rate of the time modulated pump signal comprises no more than 10 megahertz; and
selecting another waveform characteristic of the time modulated pump signal to reduce a noise figure of the amplifier stage.

109. The method of claim 108, wherein the modulation rate of the time modulated pump signal comprises no more than 5 megahertz.

110. The method of claim 108, wherein a modulation rate of the time modulated pump signal comprises no more than 1 megahertz.

111. The method of claim 108, wherein the another waveform characteristic of the time modulated pump signal comprises a characteristic selected from a group consisting of a duty cycle, an extinction ratio, and a peak power.

112. The method of claim 108, wherein the another waveform characteristic of the time modulated pump signal comprises a duty cycle of at least twenty (20) percent.

113. The method of claim 108, wherein the another waveform characteristic of the time modulated pump signal comprises a modulation depth of no more than thirteen (13) decibels.

114. The method of claim 108, further comprising selecting a maximum gain level of the amplification stage to obtain a minimum noise figure.

115. The method of claim 108, wherein an amplified spontaneous emission penalty associated with the at least one time modulated pump signal comprises no more than fifteen (15) decibels.

116. The method of claim 108, wherein the another waveform characteristic of the time modulated pump signal is selected to maintain a ratio of a time-averaged amplified spontaneous emission (ASE) power level to a minimum ASE power level of less than thirty (30), and wherein the time-averaged ASE power level and the minimum ASE power level co-propagate with the at least one time modulated pump signal.
